(19) United States
(12) Patent Application Publication
(10) Pub. No.: US 2021/0373558 A1
(43) Pub. Date: Dec. 2, 2021

(54) CONTEXTUAL AND USER EXPERIENCE-BASED MOBILE ROBOT SCHEDULING AND CONTROL

(71) Applicant: iRobot Corporation, Bedford, MA (US)

(72) Inventors: Ryan Schneider, Arlington, MA (US); Craig Michael Butterworth, Bedford, MA (US); Sam Hong, Boston, MA (US); Stefan Zickler, Bedford, MA (US); Steven Kordell, Arlington, MA (US); Hyun Woo Paik, Bedford, MA (US); Frank Judge, Andover, MA (US); Nat Jabbawy, Needham, MA (US); Jacki Holcomb, Sudbury, MA (US); Shannon Amelia Case, Woburn, MA (US); David M. McSweeney, North Reading, MA (US); Brandon Rohrer, Boston, MA (US); Rick Hoobler, Bedford, MA (US); Ottillia Shirhan Ni, Cambridge, MA (US)

(21) Appl. No.: 16/887,982

(22) Filed: May 29, 2020

(51) Int. Cl. G05D 1/02; B25J 5/00; B25J 11/00; G05D 1/00; G01C 21/20

(52) U.S. Cl. CPC G05D 1/0212; B25J 5/007; B25J 11/0085; G05D 2201/0203; G05D 1/0016; G01C 21/206; G05D 1/0231

(57) ABSTRACT

Described herein are systems, devices, and methods for scheduling and controlling a mobile robot using a textual and user experienced-based mission routine. In an example, a mobile cleaning robot comprises a drive system to move the mobile cleaning robot about an environment, a sensor circuit to detect an object in the environment, and a controller circuit to receive a mission routine including data representing an editable schedule including at least one of time or order for performing one or more cleaning tasks with respect to a semantically annotated object that include spatial or contextual information of the detected object, or with respect to user experience or user behavior. The controller circuit navigates the mobile cleaning robot to conduct a mission in accordance with the mission routine.

### TECHNICAL FIELD

This document relates generally to mobile robots and, more particularly, to systems, devices, and methods for scheduling and controlling a mobile robot based on contextual information and user experience.

### BACKGROUND

Autonomous mobile robots can move about an environment, and perform several functions and operations in a variety of categories, including but not limited to security operations, infrastructure or maintenance operations, navigation or mapping operations, inventory management operations, and robot/human interaction operations. Some mobile robots, known as cleaning robots, can autonomously perform cleaning tasks within an environment, e.g., a home. Many kinds of cleaning robots are autonomous to some degree and in different ways. For example, a cleaning robot can conduct cleaning missions, where the robot traverses and simultaneously ingests (e.g., vacuums) debris from the floor surface of their environment.

Some mobile robots are capable of storing a map of the robot environment. The mobile robot can use the map to fulfill its goals such as path planning, or navigating the mobile robot in the environment to perform a mission such as a cleaning mission.

### SUMMARY

An autonomous mobile robot (hereinafter the “mobile robot”) may be controlled locally (e.g. via controls on the robot) or remotely (e.g. via a remote handheld device) to move about an environment. In an example of remote mission scheduling and robot control, a mobile application, such as implemented in a handheld computing device (e.g., a mobile phone), may display various information organized in at-a-glance views. A user may use the mobile application to manage (e.g., add or remove) one or more mobile robots such as in the user's home, and monitor the operating status of a mobile robot. Additionally, the user may use the mobile application to create and maintain a personalized mission routine. The mission routine may be represented by an editable schedule, including time and/or order, for performing one or more tasks, such as cleaning one or more rooms or floor surface areas of the user's home. The mission routine or a task therein may be characterized by, or made reference to, a semantically annotated object. A semantically annotated object is an object detected in the environment that is associated with semantic information such as identity, location, physical attributes, or a state of the detected object, or a spatial or contextual relationship with other objects or the environment. Additionally or alternatively, the mission routine or a task therein may be characterized by, or made reference to, user experience such as time, pattern, or manner of using a room or interacting with an object therein, user daily routines, or user behavior. The mobile application may display, such as on the handheld device, information about the mission routine, and allow a user to monitor the progress of the mission being executed. A user may make changes to a task as it is being executed. In various examples, the mobile application may also display a map on the user interface, such as one representing a floorplan of an area where the mission is performed. Location and operating status of the robot, progress of the mission or a task therein, among other information, may be displayed during the cleaning mission. A user may use the mobile application to generate or update a map, create new regions, add or remove objects, or providing semantic annotations to the objects on the map. The user may also control the operation of the mobile robot by adjusting a navigation parameter or a mission scheduling parameter, such as time or order of one or more tasks in a mission routine,

This document describes systems, devices, and methods for scheduling a mission (e.g., a cleaning mission) for a mobile robot and controlling the mobile robot to execute the mission in accordance with the mission schedule, such as traversing rooms of a user's home and clean floor surface areas at specific time and location or in a specific manner. According to one example, a mobile cleaning robot comprises a drive system to move the mobile cleaning robot about an environment, a sensor circuit to detect an object in the environment, and a controller circuit to receive a mission routine including data representing an editable schedule including at least one of time or order for performing one or more cleaning tasks with respect to a semantically annotated object including spatial or contextual information of the detected object, or with respect to user experience or user behavior. The controller circuit may navigate the mobile cleaning robot to conduct a mission in accordance with the received mission routine.

According to an example, a handheld device comprises a user interface, a communication circuit configured to communicate with one or more mobile robots moving about an environment, such as a mobile cleaning robot, and a processor. The processor may receive from the mobile cleaning robot information about an object detected in the environment, and receive a mission routine including data representing an editable schedule including at least one of time or order for performing one or more cleaning tasks with respect to a semantically annotated object, the semantically annotated object including spatial and contextual information of the detected object. The handheld device may generate instructions to navigate the mobile cleaning robot to conduct a mission in accordance with the received mission routine. The user interface may display in separate categories graphical representations of the mobile cleaning robot and the mission routine.

According to an example, a non-transitory machine-readable storage medium includes instructions executable by one or more processors of a machine, such as an mobile application executable by a mobile device. Execution of the said instructions (e.g., mobile application) may cause the machine to perform operations comprising: establishing communication between the machine and at least one mobile cleaning robot configured to move about an environment; receiving information about an object in the environment detected by the at least one mobile cleaning robot; receiving a mission routine including data representing an editable schedule including at least one of time or order for performing one or more cleaning tasks with respect to a semantically annotated object, the semantically annotated object including spatial or contextual information of the detected object; presenting on a display a graphical representation of the mission routine; and navigating the at least one mobile cleaning robot to conduct a mission in accordance with the received mission routine.

Example 1 is a mobile cleaning robot that comprises: a drive system configured to move the mobile cleaning robot about an environment, a sensor circuit configured to detect an object in the environment, and a controller circuit. The controller circuit is configured to receive a mission routine including data representing an editable schedule including at least one of time or order for performing one or more tasks with respect to a semantically annotated object, the semantically annotated object including spatial or contextual information of the detected object, and navigate the mobile cleaning robot to conduct a mission in accordance with the mission routine.

In Example 2, the subject matter of Example 1 optionally includes the sensor circuit that can be further configured to identify a spatial location of the detected object in the environment; and the controller circuit is configured to associate the detected object with the identified spatial location to create the semantically annotated object, and to generate or modify the mission routine using the semantically annotated object.

In Example 3, the subject matter of Example 2 optionally includes the detected object that can include a furniture or a furnishing, and the controller circuit can be configured to identify a room or an area in the environment where the furniture or furnishing is located, associate the furniture or the furnishing with the identified room, and generate or modify the mission routine based on the association between the furniture or furnishing and the identified room or area.

In Example 4, the subject matter of any one or more of Examples 1-3 optionally includes the one or more tasks that can include cleaning one or more rooms or floor surface areas respectively characterized by their spatial or contextual relationship with the semantically annotated object.

In Example 5, the subject matter of any one or more of Examples 1-4 optionally includes the one or more tasks that can include cleaning one or more rooms or floor surface areas respectively characterized by a user interaction therewith.

In Example 6, the subject matter of any one or more of Examples 1-5 optionally includes the editable schedule for performing the one or more tasks that can he with respect to a user behavior. The controller circuit can be configured to receive information about the user behavior, and to navigate the mobile cleaning robot to conduct the mission based on the editable schedule and the received information about user behavior.

In Example 7, the subject matter of Example 6 optionally includes the controller circuit that can be configured to modify at least one of time or order for performing the one or more tasks based on the received information about user behavior.

In Example 8, the subject matter of Example 7 optionally includes the information about user behavior that can include information about room occupancy indicating a presence or absence of a person in a target room, and the controller circuit can be configured to pause the mission, or to reschedule a task to be performed in the target room based on the information about room occupancy.

In Example 9, the subject matter of any one or more of Examples 7-8 optionally includes the information about user behavior that can include information about user engagement in an audio-sensitive event, and the controller circuit can be configured to pause the mission, or to reschedule a task interfering with the audio-sensitive event.

In Example 10, the subject matter of any one or more of Examples 1-9 optionally includes the one or more tasks that can include cleaning one or more rooms or floor surface areas characterized by respective debris status therein. The sensor circuit can be configured to detect respective levels of dirtiness or debris distributions in one or more rooms or floor surface areas, and the controller circuit can be configured to prioritize cleaning the one or more rooms or floor surface areas by the respective levels of dirtiness or debris distributions.

In Example 11, the subject matter of Example 10 optionally includes the one or more tasks that can include a first area having a higher level of dirtiness than a second area, which has a higher level of dirtiness than a third area, and wherein the controller circuit is configured to navigate the mobile cleaning robot to clean sequentially the first area first, following by the second area, followed by the third area.

In Example 12, the subject matter of any one or more of Examples 1-11 optionally includes the mission routine that can further include a cleaning mode representing a level of cleaning in a target area, and the controller circuit can be configured to communicate with a light source to adjust illumination of the target area, and to navigate the mobile cleaning robot to clean the target area with the adjusted illumination.

In Example 13, the subject matter of any one or more of Examples 1-12 optionally includes the controller circuit that can be configured to generate a mission status report of a progress of the mission or a task therein, the mission status report including at least one of elapsed time, remaining time estimate, or an overall time estimate for the mission or a task therein.

In Example 14, the subject matter of any one or more of Examples 1-13 optionally includes the controller circuit that can be configured to prioritize a task in the mission routine based on a time allocation for completing a mission.

In Example 15, the subject matter of any one or more of Examples 1-14 optionally includes the controller circuit that can be configured to generate or update a map of the environment including information about the semantically annotated object, and to navigate the mobile cleaning robot using the generated map.

Example 16 is a non-transitory machine-readable storage medium that includes instructions that, when executed by one or more processors of a machine, cause the machine to perform operations comprising: establishing communication between the machine and at least one mobile cleaning robot configured to move about an environment; controlling the at least one mobile cleaning robot to detect an object in the environment; receiving a mission routine including data representing an editable schedule including at least one of time or order for performing one or more tasks with respect to a semantically annotated object, the semantically annotated object including spatial or contextual information of the detected object; presenting on a display a graphical representation of the mission routine; and navigating the at least one mobile cleaning robot to conduct a mission in accordance with the mission routine.

In Example 17, the subject matter of Example 16 optionally includes the instructions that cause the machine to perform operations further comprising coordinating a suite of mobile robots in the environment including a first mobile cleaning robot and a different second mobile robot, the editable schedule including at least one of time or order for performing one or more tasks performed by the first mobile cleaning robot and one or more tasks performed by the second mobile robot.

In Example 18, the subject matter of Example 17 optionally includes the instructions that cause the machine to perform operations further comprising, in response to a user input, switching between a presentation of an operating status of the first mobile cleaning robot and a presentation of an operating status of the second mobile cleaning robot on a user interface.

In Example 19, the subject matter of any one or more of Examples 17-18 optionally includes the operation of coordinating a suite of mobile robots that can include adding a new mobile robot to the suite or removing an existing robot from the suite.

In Example 20, the subject matter of any one or more of Examples 16-19 optionally includes the one or more tasks that can include cleaning one or more rooms or floor surface areas respectively characterized by their spatial or contextual relationship with the semantically annotated object.

In Example 21, the subject matter of any one or more of Examples 16-20 optionally includes the one or more tasks that can include cleaning one or more rooms or floor surface areas respectively characterized by a user interaction therewith.

In Example 22, the subject matter of any one or more of Examples 16-21 optionally includes editable schedule for performing the one or more tasks that can be with respect to a user behavior. The instructions cause the machine to perform operations that can further comprise: receiving information about user behavior, and navigating the at least one mobile cleaning robot to conduct the mission based on the editable schedule and the received information about user behavior.

In Example 23, the subject matter of Example 22 optionally includes the information about user behavior that can include room occupancy indicating a presence or absence of a person in a room. The instructions cause the machine to perform operations that can further comprise pausing the mission, or rescheduling a task to be performed in the room being occupied.

In Example 24, the subject matter of any one or more of Examples 22-23 optionally includes the information about user behavior that can include an audio-sensitive event. The instructions cause the machine to perform operations that can further comprise pausing the mission, or rescheduling a task that interferes with the audio-sensitive event.

In Example 25, the subject matter of any one or more of Examples 16-24 optionally includes the one or more tasks that can include cleaning one or more rooms or floor surface areas characterized by respective debris status therein. The instructions cause the machine to perform operations can further comprise: detecting respective levels of dirtiness or debris distributions in one or more rooms or floor surface areas; and prioritizing cleaning the one or more rooms or floor surface areas by the respective levels of dirtiness or debris distributions.

Example 26 is a handheld computing device, comprising a user interface, a communication circuit configured to communicate with a first mobile cleaning robot moving about an environment, and a processor. The processor is configured to receive, from the first mobile cleaning robot, information about an object detected in the environment, receive a mission routine including data representing an editable schedule including at least one of time or order for performing one or more tasks with respect to a semantically annotated object, the semantically annotated object including spatial and contextual information of the detected object, and generate instructions to navigate the first mobile cleaning robot to conduct a mission in accordance with the mission routine. The user interface can be configured to display in separate categories graphical representations of the first mobile cleaning robot and the mission routine.

In Example 27, the subject matter of Example 26 optionally includes the processor that can be configured to generate a mission status report of a progress of the mission or a task therein, the mission status report including at least one of elapsed time, remaining time estimate, or an overall time estimate for the mission or a task therein. The user interface can be configured to display in a separate category a graphical representation of the mission status report.

In Example 28, the subject matter of any one or more of Examples 26-27 optionally includes the processor that can include configured to coordinate a suite of mobile robots in the environment including the first mobile cleaning robot and a different second mobile robot. The user interface can include one or more user controls that enable a user to switch between a first graphical representation of an operating status of the first mobile cleaning robot, and a second graphical representation of an operating status of the second mobile robot.

In Example 29, the subject matter of Example 28 optionally includes the user interface that can include one or more user controls that enable a user to coordinate the suite of mobile robots including to add a new mobile robot to the suite, or to remove an existing robot from the suite.

In Example 30, the subject matter of any one or more of Examples 26-29 optionally includes the user interface that can be configured to display a graphical representation the mission routine including an indented list of the one or more tasks characterized by respective semantically annotated objects in respective rooms or surface areas in the environment.

In Example 31, the subject matter of any one or more of Examples 26-30 optionally includes the one or more tasks that can include cleaning one or more rooms or floor surface areas respectively characterized by their spatial or contextual relationship with the semantically annotated object.

In Example 32, the subject matter of any one or more of Examples 31 optionally includes the one or more tasks that can include cleaning one or more rooms or floor surface areas respectively characterized by a user interaction therewith.

In Example 33, the subject matter of any one or more of Examples 26-32 optionally includes the editable schedule for performing the one or more tasks that can be with respect to a user behavior. The processor can be configured to receive information about the user behavior, and to generate instructions to navigate the mobile cleaning robot to conduct the mission based on the editable schedule and the received information about user behavior.

In Example 34, the subject matter of any one or more of Examples 26-33 optionally includes the user interface that can be configured to receive from a user a voice command about the mission routine.

This summary is an overview of some of the teachings of the present application and not intended to be an exclusive or exhaustive treatment of the present subject matter. Further details about the present subject matter are found in the detailed description and appended claims. Other aspects of the disclosure will be apparent to persons skilled in the art upon reading and understanding the following detailed description and viewing the drawings that form a part thereof, each of which are not to be taken in a limiting sense. The scope of the present disclosure is defined by the appended claims and their legal equivalents.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIGS. 1, 2A, and 2B are side cross-sectional, bottom, and top perspective views of a mobile robot.

FIG. 3 is a diagram illustrating an example of a control architecture for operating a mobile cleaning robot.

FIG. 4A is a diagram illustrating an example of a communication network in which a mobile cleaning robot operates and data transmission in the network.

FIG. 4B is a diagram illustrating an exemplary process of exchanging information between the mobile robot and other devices in a communication network.

FIG. 5 is a block diagram illustrating an example of a robot scheduling and controlling system.

FIG. 6A illustrates an example of a user interface (UI) of a handheld device that displays an at-a-glance view of mobile robots in a user's home and mission routines created for one or more of robots.

FIG. 6B illustrates an example of a UI of a handheld device that displays a mission routine shelf including various types of mission routines.

FIGS. 6C, 6D, and 6E are examples of a UI of a handheld device that may be used to create and maintain a mission routine.

FIG. 6F illustrates an example of a UI of a handheld device that displays information about a mission routine, including tasks included therein and a schedule for the tasks.

FIG. 6G illustrates an example of a UI of a handheld device that can monitor the progress of an ongoing mission routine.

FIG. 6H illustrates an example of a UI of a handheld device that may used to create or modify a map of the environment.

FIG. 6I illustrates an example of a UI of a handheld device that displays coaching or educational messages on various features of mission creation and robot control.

FIG. 6J illustrates an example of a UI design for a handheld device showing selectable mission routines on a display screen.

FIG. 6K illustrates an example of a UI design for a handheld device showing the progress of an ongoing mission routine on a display screen.

FIG. 7 is a flow diagram illustrating an example of a method of generating and managing a mission routine for robot scheduling and control.

FIG. 8 is a block diagram illustrating an example machine upon which any one or more of the techniques (e.g., methodologies) discussed herein may perform.

### DETAILED DESCRIPTION

An autonomous mobile robot may be controlled locally or remotely to execute a mission, such as a cleaning mission involving rooms or floor surface areas to be cleaned by a mobile cleaning robot. A user may use a remote control device to display a map of the environment, create a cleaning mission on a user interface (UI) of the remote control device, and control the mobile robot to execute the cleaning mission. Conventionally, robot scheduling and controlling is largely based on a “map-and-location” approach. For example, a cleaning mission is defined by rooms or floor surface areas, such as those identified from the map, that need to be cleaned. The map-and-location approach has several disadvantages. First, such an approach only provides a generic mission architecture. It is not customized to meet an individual user's needs or unique goals. For example, a map-and-room based cleaning mission does not accommodate a user's preferences of time, location, or a pattern of room cleaning, or the user's past experience or habit of using the mobile robot in the environment. Second, mission routines generated using the map-and-location approach lack contextual content of a mission, such as spatial and/or temporal context of the mission or a task therein. Contextual information has been widely used in natural language description of a mission or a task. For example, a cleaning mission for a mobile cleaning robot may be include a target cleaning area with reference to an object in the area, such as a piece of furniture, or a cleaning schedule (e.g., time or order) with reference to a user's behavior or daily routine. Inclusion of contextual information in a mission description enriches the content of a mission routine. In contrast, a mission or a task defined solely by a location where the mission or the task is to be performed (as with the map-and-location approach) lacks spatial or temporal context of a mission. This may limit the user's experience with mission scheduling and the usability of robot control. Third, a map-and-location approach generally requires a user to define the mission each time when he or she uses the mobile robot. A mission can includes multiple tasks each requiring scheduling. Creating a mission routine can be a tedious and time-consuming process. In practice, however, some missions are highly repeatable routines (e.g., cleaning the kitchen and dining room after meals). Repeated mission creation adds burden to a user, and increases the chance of introducing human errors or inconsistency between the missions. Finally, conventional UI of a remote control device is architected to focus on hardware and structural components (e.g., robots, rooms, or the environment). Useful information such as contextual information and user experience associated with the use of the mobile robot are not presented to the user. In some cases, contextual information or semantics of an object are buried in the UI and not easily accessible. This diminishes the user experience, and reduces the usability of the UI in scheduling and controlling the mobile robot.

The present inventors have recognized an unmet need for devices and methods for enhanced mission scheduling and mobile robot control. According to one example, a mobile cleaning robot comprises a drive system to move the mobile cleaning robot about an environment, a sensor circuit to detect an object in the environment, and a controller circuit to receive and interpret a mission routine including data representing an editable schedule including at least one of time or order for performing one or more cleaning tasks with respect to a semantically annotated object that includes spatial or contextual information of the detected object. The controller circuit may navigate the mobile cleaning robot to conduct a mission in accordance with the mission routine. According to another example, a handheld device can communicate with one or more mobile robots, receive information about an object in an environment such as detected by a mobile robot. A user may create a mission routine representing an editable schedule including at least one of time or order for performing one or more cleaning tasks with respect to a semantically annotated object that includes spatial and contextual information of the detected object. The handheld device may present, on the display, a graphical representation of the mission routine, and generate instructions to navigate the mobile cleaning robot to conduct a mission in accordance with the mission routine. According to yet another example, a mobile application can be executed by a machine, such as a mobile device, causing the machine to establish a communication with a mobile cleaning robot, receive information about an object detected in the environment, receive and interpret a mission routine including data representing an editable schedule including at least one of time or order for performing one or more cleaning tasks with respect to a semantically annotated object that includes spatial or contextual information of the detected object, present on a display a graphical representation of the mission routine, and navigate the mobile cleaning robot to conduct a mission in accordance with the mission routine,

Advantages of the systems, devices, mobile applications, and methods for scheduling and controlling of a mobile robot may include, but are not limited to, those described below and elsewhere in this document. The contextual and user experience-based mission routine discussed herein may be characterized by, or in reference to, an object in the environment, user experience or daily routine, or user behavior. For example, a cleaning mission (or a task therein) may be described using spatial or contextual information of an object (e.g., a furniture or a furnishing in a room), or a user's behavior or experience of interacting with a room or an area in the environment, such as “clean under the kitchen table”, “clean the house after I leave for work”, or “do an after-dinner clean routine”. The mobile robot can interpret such mission routine to recognize time, location, and manner of performing the tasks in a mission. Compared to location-and-map based mission, the contextual and user experience-based mission routine is architected to add a user's personalized content. As the contextual and user experience-based mission routine is more consistent with natural language description of a mission, it enables more intuitive communication between the user and the robot, such that the mobile robot may execute the mission in a commonly understandable fashion between the user and the robot. Additionally, the inclusion of the contextual information and user experience in mission description enriches the content of a mission routine, adds more intelligence to robot behavior, and enhances user experience of personalized control of the mobile robot. The contextual and user experience-based mission routine also alleviates a user's burden of repeatedly creating mission routines, and improve user experience and the robot's overall usability.

The present document also discusses a UI that present information about mission and robot control in a more user-friendly and efficient way. In an example, the IR includes an at-a-glance view of robot information, robot operating status, personalized mission routine, mission progress report, and maps of the robot environment including semantic objects, among others. The at-a-glance view may automatically and progressively present relevant information to the user based on the context of a mission, such as the robot(s) involved in a mission, nature of the mission, tasks involved in a mission, or progress of a mission, among others. The at-a-glance view may include coaching or educational messages, recommendations, interactive trouble-shooting guides, reminders to perform maintenance, or a user survey, which may enhance user experience as well as the robot's usability and efficiency.

The present document further discusses devices and methods of controlling a mobile robot with enhanced flexibility. In accordance with various examples, a mobile application, when executed by a mobile device (e.g., a mobile phone), may enable a user to manage a suite of robots such as in his/her home create and manage an editable, personalized mission routine, coordinate multiple robots to execute a mission routine, modify a mission as it is being executed, generate and manage a map such as creating new regions, adding semantic objects to the map, or removing a region or an object from the map, etc. The mobile application also enables a user to control the operation of the mobile robot by adjusting a navigation parameter or a. mission scheduling parameter, such as adding a new task, deleting a previously schedule task, or changing the time or order of one or more tasks in the mission.

The robots and techniques described herein, or portions thereof, can be controlled by a computer program product that includes instructions that are stored on one or more non-transitory machine-readable storage media, and that are executable on one or more processing devices to control (e.g., to coordinate) the operations described herein. The robots described herein, or portions thereof, can be implemented as all or part of an apparatus or electronic system that can include one or more processing devices and memory to store executable instructions to implement various operations.

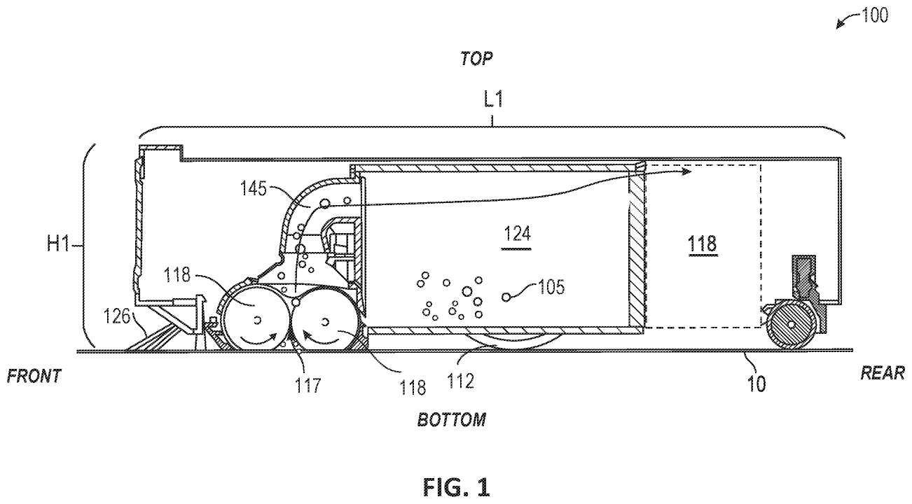

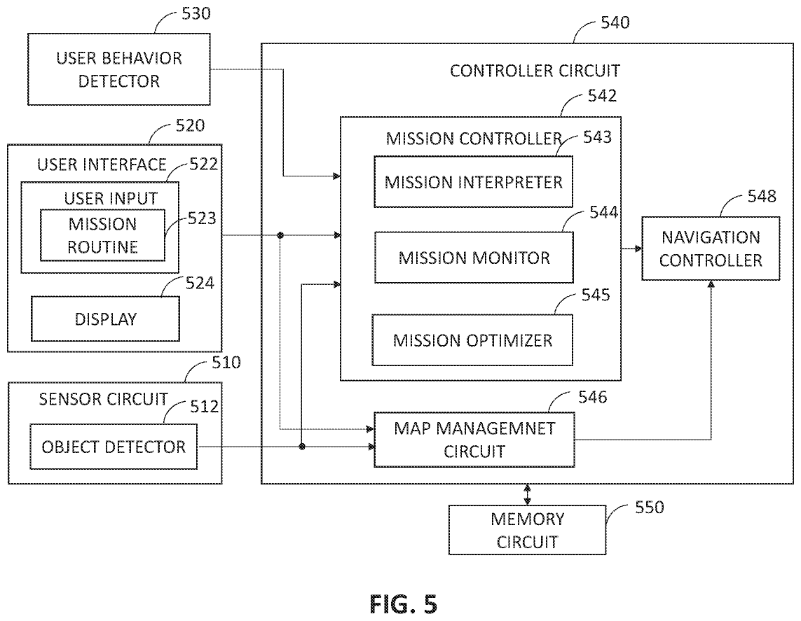

In the following, mobile robot and its working environment are briefly discussed with reference to FIGS. 1-4. Detailed descriptions of systems, devices, mobile applications, and methods of scheduling and controlling a mobile robot based on contextual information and user experience, in accordance with various embodiments described herein, are discussed with reference to FIGS. 5 to 8.

### Examples of Autonomous Mobile Robots

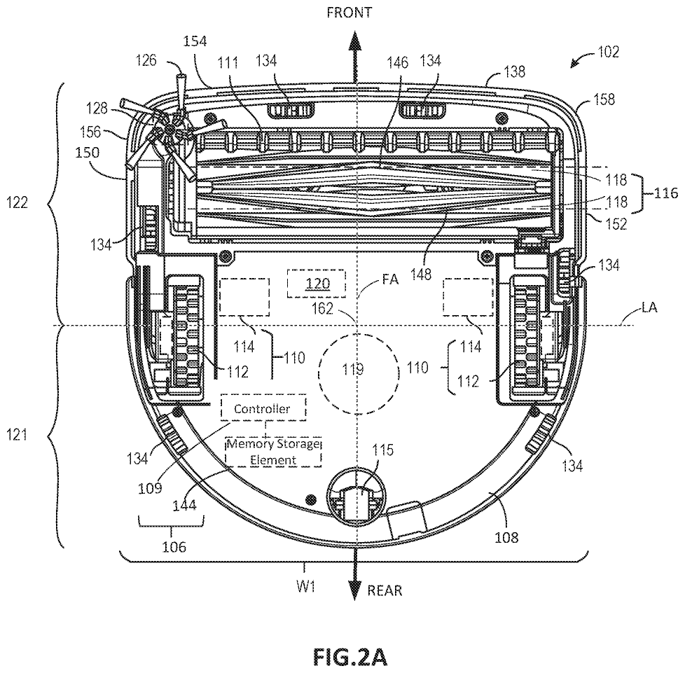

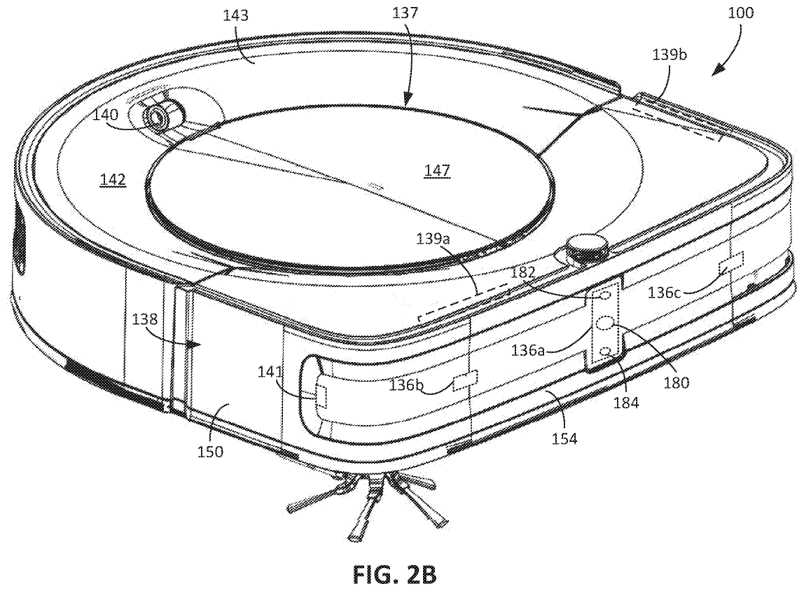

FIGS. 1 and 2A-2B depict different views of an example of a mobile robot 100. Referring to FIG. 1, the mobile robot 100 collects debris 105 from the floor surface 10 as the mobile robot 100 traverses the floor surface 10. Referring to FIG. 2A, the mobile robot 100 includes a robot housing infrastructure 108. The housing infrastructure 108 can define the structural periphery of the mobile robot 100. In some examples, the housing infrastructure 108 includes a chassis, cover, bottom plate, and bumper assembly. The mobile robot 100 is a household robot that has a small profile so that the mobile robot 100 can fit under furniture within a home. For example, a height H1 (shown in FIG. 1) of the mobile robot 100 relative to the floor surface is, for example, no more than 13 centimeters. The mobile robot 100 is also compact. An overall length L1 (shown in FIG. 1) of the mobile robot 100 and an overall width W1 (shown in FIG. 2A) are each between 30 and 60 centimeters, e.g., between 30 and 40 centimeters, 40 and 50 centimeters, or 50 and 60 centimeters. The overall width W1 can correspond to a width of the housing infrastructure 108 of the mobile robot 100.

The mobile robot 100 includes a drive system 110 including one or more drive wheels. The drive system 110 further includes one or more electric motors including electrically driven portions forming part of the electrical circuitry 106. The housing infrastructure 108 supports the electrical circuitry 106, including at least a controller circuit 109, within the mobile robot 100.

The drive system 110 is operable to propel the mobile robot 100 across the floor surface 10. The mobile robot 100 can be propelled in a forward drive direction F or a rearward drive direction R. The mobile robot 100 can also be propelled such that the mobile robot 100 turns in place or turns while moving in the forward drive direction IP or the rearward drive direction R. In the example depicted in FIG. 2A, the mobile robot 100 includes drive wheels 112 extending through a bottom portion 113 of the housing infrastructure 108. The drive wheels 112 are rotated by motors 114 to cause movement of the mobile robot 100 along the floor surface 10. The mobile robot 100 further includes a passive caster wheel 115 extending through the bottom portion 113 of the housing infrastructure 108. The caster wheel 115 is not powered. Together, the drive wheels 112 and the caster wheel 115 cooperate to support the housing infrastructure 108 above the floor surface 10. For example, the caster wheel 115 is disposed along a rearward portion 121 of the housing infrastructure 108, and the drive wheels 112 are disposed forward of the caster wheel 115.

Referring to FIG. 2B, the mobile robot 100 includes a forward portion 122 that is substantially rectangular and a rearward portion 121 that is substantially semicircular. The forward portion 122 includes side surfaces 150, 152, a forward surface 154, and corner surfaces 156, 158. The corner surfaces 156, 158 of the forward portions 122 connect the side surface 150, 152 to the forward surface 154.

In the example depicted in FIGS. 1 and 2A-2B, the mobile robot 100 is an autonomous mobile floor cleaning robot that includes a cleaning head assembly 116 (shown in FIG. 2A) operable to clean the floor surface 10. For example, the mobile robot 100 is a vacuum cleaning robot in which the cleaning head assembly 116 is operable to clean the floor surface 10 by ingesting debris 105 (shown in FIG. 1) from the floor surface 10. The cleaning head assembly 116 includes a cleaning inlet 117 through which debris is collected by the mobile robot 100. The cleaning inlet 117 is positioned forward of a center of the mobile robot 100, e.g., a center 162, and along the forward portion 122 of the mobile robot 100 between the side surfaces 150, 152 of the forward portion 122.

The cleaning head assembly 116 includes one or more rotatable members, e.g., rotatable members 118 driven by a roller motor 120. The rotatable members 118 extend horizontally across the forward portion 122 of the mobile robot 100. The rotatable members 118 are positioned along a forward portion 122 of the housing infrastructure 108, and extend along 75% to 95% of a width of the forward portion 122 of the housing infrastructure 108, e.g., corresponding to an overall width W1 of the mobile robot 100. Referring also to FIG. 1, the cleaning inlet 117 is positioned between the rotatable merribers 118.

As shown in FIG. 1, the rotatable members 118 are rollers that counter rotate relative to one another. For example, the rotatable merribers 118 can include a front roller and a rear roller mounted parallel to the floor surface and spaced apart from one another by a small elongated gap. The rotatable merribers 118 can be rotatable about parallel horizontal axes 146, 148 (shown in FIG. 2A) to agitate debris 105 on the floor surface 10 and direct the debris 105 toward the cleaning inlet 117, into the cleaning inlet 117, and into a suction pathway 145 (shown in FIG. 1) in the mobile robot 100. Referring back to FIG. 2A, the rotatable members 118 can be positioned entirely within the forward portion 122 of the mobile robot 100. The rotatable members 118 include elastomeric shells that contact debris 105 on the floor surface 10 to direct debris 105 through the cleaning inlet 117 between the rotatable members 118 and into an interior of the mobile robot 100, e.g., into a debris bin 124 (shown in FIG. 1), as the rotatable members 118 rotate relative to the housing infrastructure 108. The rotatable members 118 further contact the floor surface 10 to agitate debris 105 on the floor surface 10. In the example as illustrated in FIG. 2A, the rotatable members 118, such as front and rear rollers, may each feature a pattern of chevron-shaped vanes distributed along its cylindrical exterior, and the vanes of at least one roller make contact with the floor surface along the length of the roller and experience a consistently applied friction force during rotation that is not present with brushes having pliable bristles.

The rotatable members 118 may take other suitable configurations. In an example, at least one of the front and rear rollers may include bristles and/or elongated pliable flaps for agitating the floor surface. In an example, a flapper brush, rotatably coupled to the cleaning head assembly housing, can include a compliant flap extending radially outward from the core to sweep a floor surface as the roller is driven to rotate. The flap is configured to prevent errant filaments from spooling tightly about the core to aid subsequent removal of the filaments. The flapper brush includes axial end guards mounted on the core adjacent the ends of the outer core surface and configured to prevent spooled filaments from traversing axially from the outer core surface onto the mounting features. The flapper brush can include multiple floor cleaning bristles extending radially outward from the core.

The mobile robot 100 further includes a vacuum system 119 operable to generate an airflow through the cleaning inlet 117 between the rotatable members 118 and into the debris bin 124. The vacuum system 119 includes an impeller and a motor to rotate the impeller to generate the airflow. The vacuum system 119 cooperates with the cleaning head assembly 116 to draw debris 105 from the floor surface 10 into the debris bin 124. In some cases, the airflow generated by the vacuum system 119 creates sufficient force to draw debris 105 on the floor surface 10 upward through the gap between the rotatable members 118 into the debris bin 124. In some cases, the rotatable members 118 contact the floor surface 10 to agitate the debris 105 on the floor surface 10, thereby allowing the debris 105 to be more easily ingested by the airflow generated by the vacuum system 119.

The mobile robot 100 further includes a brush 126 (also referred to as a side brush) that rotates about a non-horizontal axis, e.g., an axis forming an angle between 75 degrees and 90 degrees with the floor surface 10. The non-horizontal axis, for example, forms an angle between 75 degrees and 90 degrees with the longitudinal axes of the rotatable members 118. The mobile robot 100 includes a brush motor 128 operably connected to the side brush 126 to rotate the side brush 126.

The brush 126 is a side brush laterally offset from a fore-aft axis FA of the mobile robot 100 such that the brush 126 extends beyond an outer perimeter of the housing infrastructure 108 of the mobile robot 100. For example, the brush 126 can extend beyond one of the side surfaces 150, 152 of the mobile robot 100 and can thereby be capable of engaging debris on portions of the floor surface 10 that the rotatable members 118 typically cannot reach, e.g., portions of the floor surface 10 outside of a portion of the floor surface 10 directly underneath the mobile robot 100. The brush 126 is also forwardly offset from a lateral axis LA of the mobile robot 100 such that the brush 126 also extends beyond the forward surface 154 of the housing infrastructure 108. As depicted in FIG. 2A, the brush 126 extends beyond the side surface 150, the corner surface 156, and the forward surface 154 of the housing infrastructure 108. In some implementations, a horizontal distance D1 that the brush 126 extends beyond the side surface 150 is at least, for example, 0.2 centimeters, e.g., at least 0.25 centimeters, at least 0.3 centimeters, at least 0.4 centimeters, at least 0.5 centimeters, at least 1 centimeter, or more. The brush 126 is positioned to contact the floor surface 10 during its rotation so that the brush 126 can easily engage the debris 105 on the floor surface 10.

The brush 126 is rotatable about the non-horizontal axis in a manner that brushes debris on the floor surface 10 into a cleaning path of the cleaning head assembly 116 as the mobile robot 100 moves. For example, in examples in which the mobile robot 100 is moving in the forward drive direction F, the brush 126 is rotatable in a clockwise direction (when viewed from a perspective above the mobile robot 100) such that debris that the brush 126 contacts moves toward the cleaning head assembly and toward a portion of the floor surface 10 in front of the cleaning head assembly 116 in the forward drive direction F. As a result, as the mobile robot 100 moves in the forward drive direction F, the cleaning inlet 117 of the mobile robot 100 can collect the debris swept by the brush 126. In examples in which the mobile robot 100 is moving in the rearward drive direction R, the brush 126 is rotatable in a counterclockwise direction (when viewed from a perspective above the mobile robot 100) such that debris that the brush 126 contacts moves toward a portion of the floor surface 10 behind the cleaning head assembly 116 in the rearward drive direction R. As a result, as the mobile robot 100 moves in the rearward drive direction R, the cleaning inlet 117 of the mobile robot 100 can collect the debris swept by the brush 126.

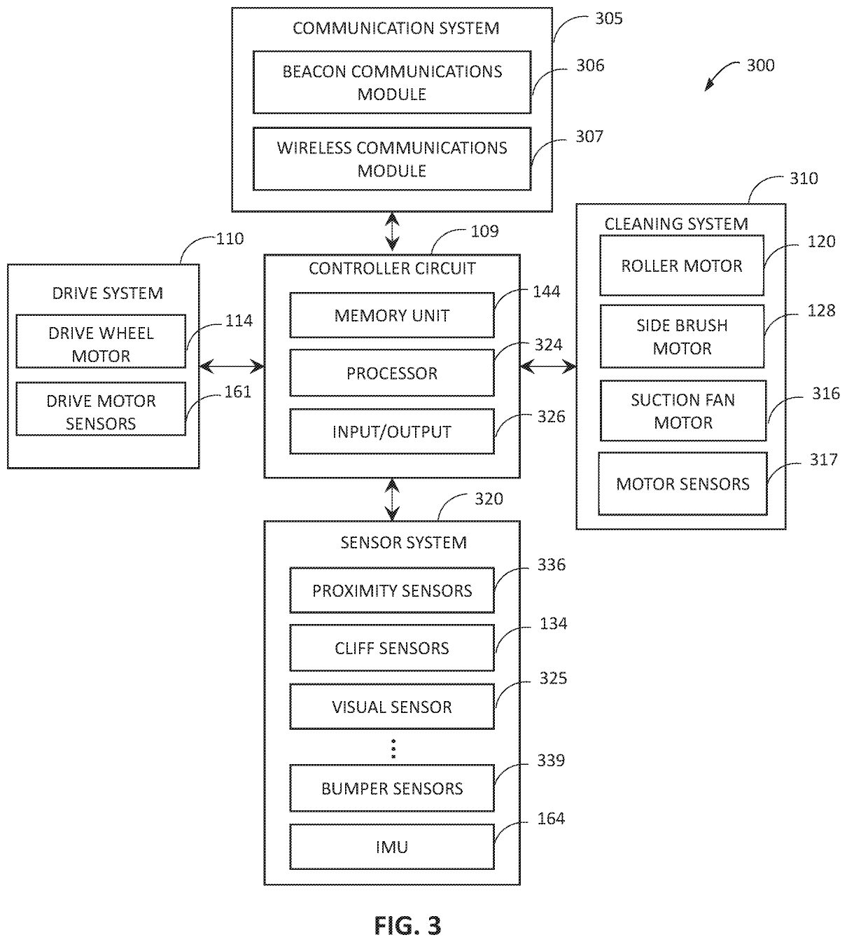

The electrical circuitry 106 includes, in addition to the controller circuit 109, a memory storage element 144 and a sensor system with one or more electrical sensors, for example. The sensor system, as described herein, can generate a signal indicative of a current location of the mobile robot 100, and can generate signals indicative of locations of the mobile robot 100 as the mobile robot 100 travels along the floor surface 10. The controller circuit 109 is configured to execute instructions to perform one or more operations as described herein. The memory storage element 144 is accessible by the controller circuit 109 and disposed within the housing infrastructure 108. The one or more electrical sensors are configured to detect features in an environment of the mobile robot 100. For example, referring to FIG. 2A, the sensor system includes cliff sensors 134 disposed along the bottom portion 113 of the housing infrastructure 108. Each of the cliff sensors 134 is an optical sensor that can detect the presence or the absence of an object below the optical sensor, such as the floor surface 10. The cliff sensors 134 can thus detect obstacles such as drop-offs and cliffs below portions of the mobile robot 100 where the cliff sensors 134 are disposed and redirect the robot accordingly. More details of the sensor system and the controller circuit 109 are discussed below, such as with reference to FIG. 3.

Referring to FIG. 2B, the sensor system includes one or more proximity sensors that can detect objects along the floor surface 10 that are near the mobile robot 100. For example, the sensor system can include proximity sensors 136a, 136b, 136c disposed proximate the forward surface 154 of the housing infrastructure 108. Each of the proximity sensors 136a, 136b, 136c includes an optical sensor facing outward from the forward surface 154 of the housing infrastructure 108 and that can detect the presence or the absence of an object in front of the optical sensor. For example, the detectable objects include obstacles such as furniture, walls, persons, and other objects in the environment of the mobile robot 100.

The sensor system includes a bumper system including the bumper 138 and one or more bump sensors that detect contact between the bumper 138 and obstacles in the environment. The bumper 138 forms part of the housing infrastructure 108. For example, the bumper 138 can form the side surfaces 150, 152 as well as the forward surface 154. The sensor system, for example, can include the bump sensors 139a, 139b. The bump sensors 139a, 139b can include break beam sensors, capacitive sensors, or other sensors that can detect contact between the mobile robot 100, e.g., the bumper 138, and objects in the environment. In some implementations, the bump sensor 139a can be used to detect movement of the bumper 138 along the fore-aft axis FA (shown in FIG. 2A) of the mobile robot 100, and the bump sensor 139b can be used to detect movement of the bumper 138 along the lateral axis LA (shown in FIG. 2A) of the mobile robot 100. The proximity sensors 136a, 136b, 136c can detect objects before the mobile robot 100 contacts the objects, and the bump sensors 139a, 139b can detect objects that contact the bumper 138, e.g., in response to the mobile robot 100 contacting the objects.

The sensor system includes one or more obstacle following sensors. For example, the mobile robot 100 can include an obstacle following sensor 141 along the side surface 150. The obstacle following sensor 141 includes an optical sensor facing outward from the side surface 150 of the housing infrastructure 108 and that can detect the presence or the absence of an object adjacent to the side surface 150 of the housing infrastructure 108. The obstacle following sensor 141 can emit an optical beam horizontally in a direction perpendicular to the forward drive direction F of the mobile robot 100 and perpendicular to the side surface 150 of the mobile robot 100. For example, the detectable objects include obstacles such as furniture, walls, persons, and other objects in the environment of the mobile robot 100. In some implementations, the sensor system can include an obstacle following sensor along the side surface 152, and the obstacle following sensor can detect the presence or the absence an object adjacent to the side surface 152. The obstacle following sensor 141 along the side surface 150 is a right obstacle following sensor, and the obstacle following sensor along the side surface 152 is a left obstacle following sensor. The one or more obstacle following sensors, including the obstacle following sensor 141, can also serve as obstacle detection sensors, e.g., similar to the proximity sensors described herein. In this regard, the left obstacle following can be used to determine a distance between an object, e.g., an obstacle surface, to the left of the mobile robot 100 and the mobile robot 100, and the right obstacle following sensor can be used to determine a distance between an object, e.g., an obstacle surface, to the right of the mobile robot 100 and the mobile robot 100.

In some implementations, at least some of the proximity sensors 136a, 136b, 136c, and the obstacle following sensor 141 each includes an optical emitter and an optical detector. The optical emitter emits an optical beam outward from the mobile robot 100, e.g., outward in a horizontal direction, and the optical detector detects a reflection of the optical beam that reflects off an object near the mobile robot 100. The mobile robot 100, e.g., using the controller circuit 109, can determine a time of flight of the optical beam and thereby determine a distance between the optical detector and the object, and hence a distance between the mobile robot 100 and the object.

In some implementations, the proximity sensor 136a includes an optical detector 180 and multiple optical emitters 182, 184. One of the optical emitters 182, 184 can be positioned to direct an optical beam outwardly and downwardly, and the other of the optical emitters 182, 184 can be positioned to direct an optical beam outwardly and upwardly. The optical detector 180 can detect reflections of the optical beams or scatter from the optical beams. In some implementations, the optical detector 180 is an imaging sensor, a camera, or some other type of detection device for sensing optical signals. In some implementations, the optical beams illuminate horizontal lines along a planar vertical surface forward of the mobile robot 100. In some implementations, the optical emitters 182, 184 each emit a fan of beams outward toward an obstacle surface such that a one-dimensional grid of dots appear on one or more obstacle surfaces. The one-dimensional grid of dots can be positioned on a horizontally extending line. In some implementations, the grid of dots can extend across multiple obstacle surfaces, e.g., multiple obstacle surfaces adjacent to one another. The optical detector 180 can capture an image representative of the grid of dots formed by the optical emitter 182 and the grid of dots formed by the optical emitter 184. Based on a size of a dot in the image, the mobile robot 100 can determine a distance of an object on which the dot appears relative to the optical detector 180, e.g., relative to the mobile robot 100. The mobile robot 100 can make this determination for each of the dots, thus allowing the mobile robot 100 to determine a shape of an object on which the dots appear. In addition, if multiple objects are ahead of the mobile robot 100, the mobile robot 100 can determine a shape of each of the objects. In some implementations, the objects can include one or more objects that are laterally offset from a portion of the floor surface 10 directly in front of the mobile robot 100.

The sensor system further includes an image capture device 140, e.g., a camera, directed toward a top portion 142 of the housing infrastructure 108. The image capture device 140 generates digital imagery of the environment of the mobile robot 100 as the mobile robot 100 moves about the floor surface 10. The image capture device 140 is angled in an upward direction, e.g., angled between 30 degrees and 80 degrees from the floor surface 10 about which the mobile robot 100 navigates. The camera, when angled upward, is able to capture images of wall surfaces of the environment so that features corresponding to objects on the wall surfaces can be used for localization.

When the controller circuit 109 causes the mobile robot 100 to perform the mission, the controller circuit 109 operates the motors 114 to drive the drive wheels 112 and propel the mobile robot 100 along the floor surface 10. In addition, the controller circuit 109 operates the roller motor 120 to cause the rotatable members 118 to rotate, operates the brush motor 128 to cause the side brush 126 to rotate, and operates the motor of the vacuum system 119 to generate the airflow. To cause the mobile robot 100 to perform various navigational and cleaning behaviors, the controller circuit 109 executes software stored on the memory storage element 144 to cause the mobile robot 100 to perform by operating the various motors of the mobile robot 100. The controller circuit 109 operates the various motors of the mobile robot 100 to cause the mobile robot 100 to perform the behaviors.

The sensor system can further include sensors for tracking a distance travelled by the mobile robot 100. For example, the sensor system can include encoders associated with the motors 114 for the drive wheels 112, and these encoders can track a distance that the mobile robot 100 has travelled. In some implementations, the sensor system includes an optical sensor facing downward toward a floor surface. The optical sensor can be an optical mouse sensor. For example, the optical sensor can be positioned to direct light through a bottom surface of the mobile robot 100 toward the floor surface 10. The optical sensor can detect reflections of the light and can detect a distance travelled by the mobile robot 100 based on changes in floor features as the mobile robot 100 travels along the floor surface 10.

The controller circuit 109 uses data collected by the sensors of the sensor system to control navigational behaviors of the mobile robot 100 during the mission. For example, the controller circuit 109 uses the sensor data collected by obstacle detection sensors of the mobile robot 100, e.g., the cliff sensors 134, the proximity sensors 136a, 136b, 136c, and the bump sensors 139a, 139b, to enable the mobile robot 100 to avoid obstacles or to prevent from falling down stairs within the environment of the mobile robot 100 during the mission. In some examples, the controller circuit 109 controls the navigational behavior of the mobile robot 100 using information about the environment, such as a map of the environment. With proper navigation, the mobile robot 100 is able to reach a goal position or completes a coverage mission as efficiently and as reliably as possible.

The sensor data can be used by the controller circuit 109 for simultaneous localization and mapping (SLAM) techniques in which the controller circuit 109 extracts features of the environment represented by the sensor data and constructs a map of the floor surface 10 of the environment. The sensor data collected by the image capture device 140 can be used for techniques such as vision-based SLAM (VSLAM) in which the controller circuit 109 extracts visual features corresponding to objects in the environment and constructs the map using these visual features. As the controller circuit 109 directs the mobile robot 100 about the floor surface 10 during the mission, the controller circuit 109 uses SLAM techniques to determine a location of the mobile robot 100 within the map by detecting features represented in collected sensor data and comparing the features to previously stored features. The map formed from the sensor data can indicate locations of traversable and nontraversable space within the environment. For example, locations of obstacles are indicated on the map as nontraversable space, and locations of open floor space are indicated on the map as traversable space.

The sensor data collected by any of the sensors can be stored in the memory storage element 144. In addition, other data generated for the SLAM techniques, including mapping data forming the map, can be stored in the memory storage element 144. These data produced during the mission can include persistent data that are produced during the mission and that are usable during a further mission. For example, the mission can be a first mission, and the further mission can be a second mission occurring after the first mission, in addition to storing the software for causing the mobile robot 100 to perform its behaviors, the memory storage element 144 stores sensor data or data resulting from processing of the sensor data for access by the controller circuit 109 from one mission to another mission. For example, the map can be a persistent map that is usable and updateable by the controller circuit 109 of the mobile robot 100 from one mission to another mission to navigate the mobile robot 100 about the floor surface 10. According to various embodiments discussed in this document, the persistent map can be updated in response to instruction commands received from a user. The controller circuit 109 can modify subsequent or future navigational behaviors of the mobile robot 100 according to the updated persistent map, such as by modifying the planned path or updating obstacle avoidance strategy.

The persistent data, including the persistent map, enables the mobile robot 100 to efficiently clean the floor surface 10. For example, the persistent map enables the controller circuit 109 to direct the mobile robot 100 toward open floor space and to avoid nontraversable space. In addition, for subsequent missions, the controller circuit 109 is able to plan navigation of the mobile robot 100 through the environment using the persistent map to optimize paths taken during the missions.

The mobile robot 100 can, in some implementations, include a light indicator system 137 located on the top portion 142 of the mobile robot 100. The light indicator system 137 can include light sources positioned within a lid 147 covering the debris bin 124 (shown in FIG. 2A). The light sources can be positioned to direct light to a periphery of the lid 147. The light sources are positioned such that any portion of a continuous loop 143 on the top portion 142 of the mobile robot 100 can be illuminated. The continuous loop 143 is located on a recessed portion of the top portion 142 of the mobile robot 100 such that the light sources can illuminate a surface of the mobile robot 100 as they are activated.

FIG. 3 is a diagram illustrating an example of a control architecture 300 for operating a mobile cleaning robot. The controller circuit 109 can be communicatively coupled to various subsystems of the mobile robot 100, including a communications system 305, a cleaning system 310, a drive system 110, and a sensor system 320. The controller circuit 109 includes a memory storage element 144 that holds data and instructions for processing by a processor 324. The processor 324 receives program instructions and feedback data from the memory storage element 144, executes logical operations called for by the program instructions, and generates command signals for operating the respective subsystem components of the mobile robot 100. An input/output unit 326 transmits the command signals and receives feedback from the various illustrated components.

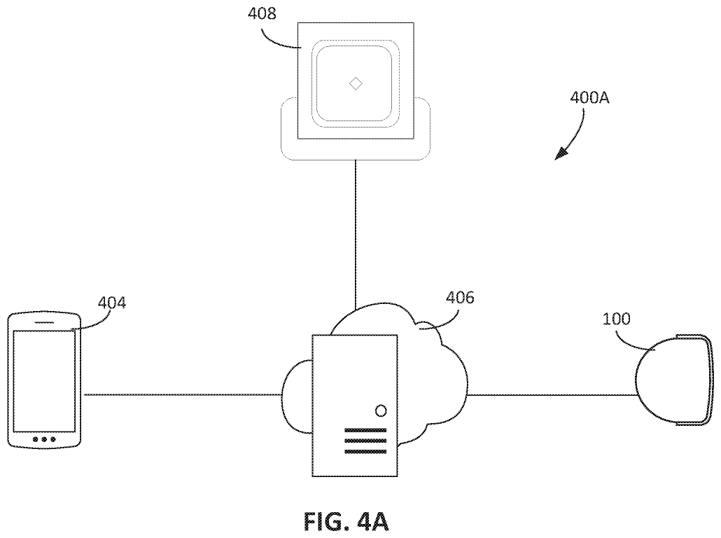

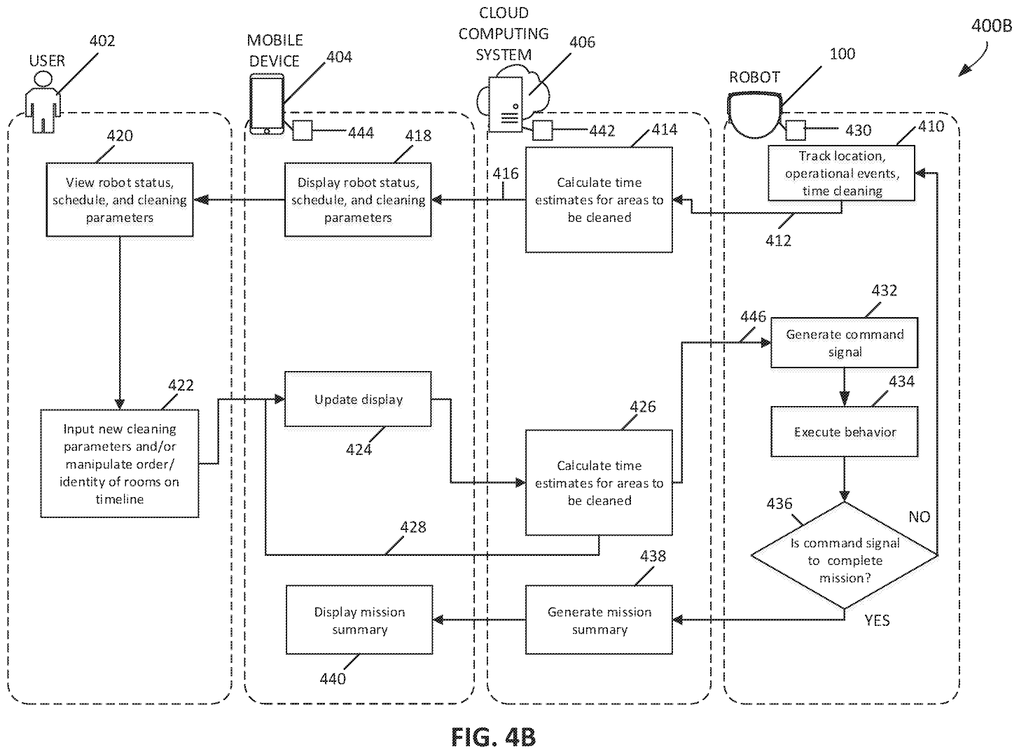

The communications system 305 can include a beacon communications module 306 and a wireless communications module 307. The beacon communications module 306 may be communicatively coupled to the controller circuit 109, in some embodiments, the beacon communications module 306 is operable to send and receive signals to and from a remote device. For example, the beacon communications module 306 may detect a navigation signal projected from an emitter of a navigation or virtual wall beacon or a homing signal projected from the emitter of a docking station. Docking, confinement, home base, and homing technologies are discussed in U.S. Pat. Nos. 7,196,487 and 7,404,000, U.S. Patent Application Publication No. 20050156562, and U.S. Patent Application Publication No. 20140100693 (the entireties of which are hereby incorporated by reference). As described in U.S. Patent Publication 2014/0207282 (the entirety of which is hereby incorporated by reference), the wireless communications module 307 facilitates the communication of information describing a status of the mobile robot 100 over a suitable wireless network (e.g., a wireless local area network) with one or more mobile devices (e.g., mobile device 404 shown in FIG. 4A). More details of the communications system 305 are discussed below, such as with reference to FIG. 4A.

The cleaning system 310 can include the roller motor 120, a brush motor 128 driving the side brush 126, and a suction fan motor 316 powering the vacuum system 119. The cleaning system 310 further includes multiple motor sensors 317 that monitor operation of the roller motor 120, the brush motor 128, and the suction fan motor 316 to facilitate closed-loop control of the motors by the controller circuit 109. In some embodiments, the roller motor 120 is operated by the controller circuit 109 for a suitable microcontroller) to drive the rollers (e.g., rotatable members 118) according to a particular speed setting via a closed-loop pulse-width modulation (PWM) technique, where the feedback signal is received from a motor sensor 317 monitoring a signal indicative of the rotational speed of the roller motor 120. For example, such a motor sensor 317 may be provided in the form of a motor current sensor (e.g., a shunt resistor, a current-sensing transformer, and/or a Hall Effect current sensor).

The drive system 110 can include a drive-wheel motor 114 for operating the drive wheels 112 in response to drive commands or control signals from the controller circuit 109. as well as multiple drive motor sensors 161 to facilitate closed-loop control of the drive wheels (e.g., via a suitable PWM technique as described above). In some implementations, a microcontroller assigned to the drive system 110 is configured to decipher drive commands having x, y, and θ components. The controller circuit 109 may issue individual control signals to the drive wheel motor 114. In any event, the controller circuit 109 can maneuver the mobile robot 100 in any direction across a cleaning surface by independently controlling the rotational speed and direction of each drive wheel 112 via the drive-wheel motor 114.

The controller circuit 109 can operate the drive system 110 in response to signals received from the sensor system 320. For example, the controller circuit 109 may operate the drive system 110 to redirect the mobile robot 100 to avoid obstacles and clutter encountered while treating a floor surface. In another example, if the mobile robot 100 becomes stuck or entangled during use, the controller circuit 109 may operate the drive system 110 according to one or more escape behaviors. To achieve reliable autonomous movement, the sensor system 320 may include several different types of sensors that can be used in combination with one another to allow the mobile robot 100 to make intelligent decisions about a particular environment. By way of example and not limitation, the sensor system 320 can include one or more of proximity sensors 336 (such as the proximity sensors 136a-136c), the cliff sensors 134, a visual sensor 325 such as the image capture device 140 configured for detecting features and landmarks in the operating environment and building a virtual map, such as using VSLAM technology, as described above.

The sensor system 320 may further include bumper sensors 339 (such as the bumper sensors 139a and 139b), responsive to activation of the bumper 138. The sensor system 320 can include an inertial measurement unit (MU) 164 that is, in part, responsive to changes in position of the mobile robot 100 with respect to a vertical axis substantially perpendicular to the floor and senses when the mobile robot 100 is pitched at a floor type interface having a difference in height, which is potentially attributable to a flooring type change. In some examples, the IMU 164 is a six-axis IMU having a gyro sensor that measures the angular velocity of the mobile robot 100 relative to the vertical axis. However, other suitable configurations are also contemplated. For example, the IMU 164 may include an accelerometer sensitive to the linear acceleration of the mobile robot 100 along the vertical axis. In any event, output from the IMU 164 is received by the controller circuit 109 and processed to detect a discontinuity in the floor surface across which the mobile robot 100 is traveling. Within the context of the present disclosure the terms “flooring discontinuity” and “threshold” refer to any irregularity in the floor surface (e.g., a change in flooring type or change in elevation at a flooring interface) that is traversable by the mobile robot 100, but that causes a discrete vertical movement event (e.g., an upward or downward “bump”). The vertical movement event could refer to a part of the drive system (e.g., one of the drive wheels 112) or the chassis of the robot housing 108, depending on the configuration and placement of the IMU 164. Detection of a flooring threshold, or flooring interface, may prompt the controller circuit 109 to expect a change in floor type. For example, the mobile robot 100 may experience a significant downward vertical bump as it moves from high pile carpet (a soft floor surface) to a tile floor (a hard floor surface), and an upward bump in the opposite case.

A wide variety of other types of sensors, though not shown or described in connection with the illustrated examples, may be incorporated in the sensor system 320 (or any other subsystem) without departing from the scope of the present disclosure. Such sensors may function as obstacle detection units, obstacle detection obstacle avoidance (ODOA) sensors, wheel drop sensors, obstacle-following sensors, stall-sensor units, drive-wheel encoder units, bumper sensors, and the like.

### Examples of Communication Networks

FIG. 4A is a diagram illustrating by way of example and not limitation a communication network 400A that enables networking between the mobile robot 100 and one or more other devices, such as a mobile device 404, a cloud computing system 406, or another autonomous robot 408 separate from the mobile device 404. Using the communication network 400A, the mobile robot 100, the mobile device 404, the robot 408, and the cloud computing system 406 can communicate with one another to transmit data to one another and receive data from one another. In some implementations, the mobile robot 100, the robot 408, or both the mobile robot 100 and the robot 408 communicate with the mobile device 404 through the cloud computing system 406. Alternatively or additionally, the mobile robot 100, the robot 408, or both the mobile robot 100 and the robot 408 communicate directly with the mobile device 404. Various types and combinations of wireless networks (e.g., Bluetooth, radio frequency, optical based, etc.) and network architectures (e.g., mesh networks) may be employed by the communication network 400A.

In some implementations, the mobile device 404 as shown in FIG. 4A is a remote device that can be linked to the cloud computing system 406, and can enable a user to provide inputs on the mobile device 404. The mobile device 404 can include user input elements such as, for example, one or more of a touchscreen display, buttons, a microphone, a mouse, a keyboard, or other devices that respond to inputs provided by the user. The mobile device 404 alternatively or additionally includes immersive media (e.g., virtual reality) with which the user interacts to provide a user input. The mobile device 404, in these cases, is, for example, a virtual reality headset or a head-mounted display. The user can provide inputs corresponding to commands for the mobile device 404. In such cases, the mobile device 404 transmits a signal to the cloud computing system 406 to cause the cloud computing system 406 to transmit a command signal to the mobile robot 100. In some implementations, the mobile device 404 can present augmented reality images, in some implementations, the mobile device 404 is a smart phone, a laptop computer, a tablet computing device, or other mobile device.

According to various embodiments discussed herein, the mobile device 404 may include a user interface configured to display a map of the robot environment. Robot path, such as that identified by the coverage planner of the controller circuit 109, may also be displayed on the map. The interface may receive a user instruction to modify the environment map, such as by adding, removing, or otherwise modifying a keep-out traversable zone in the environment; adding, removing, or otherwise modifying a duplicate traversal zone in the environment (such as an area that requires repeated cleaning); restricting a robot traversal direction or traversal pattern in a portion of the environment; or adding or changing a cleaning rank, among others.

In some implementations, the communication network 400A can include additional nodes. For example, nodes of the communication. network 400A can include additional robots. Alternatively or additionally. nodes of the communication network 400A can include network-connected devices. In some implementations, a network-connected device can generate information about the environment 20. The network-connected device can include one or more sensors to detect features in the environment 20, such as an acoustic sensor, an image capture system, or other sensor generating signals from which features can be extracted. Network-connected devices can include home cameras, smart sensors, and the like.

In the communication network 400A depicted in FIG. 4A and in other implementations of the communication network 400A, the wireless links may utilize various communication schemes, protocols, etc., such as, for example, Bluetooth classes, Wi-Fi, Bluetooth-low-energy, also known as BLE, 802.15.4, Worldwide Interoperability for Microwave Access (WiMAX), an infrared channel or satellite band. In some cases, the wireless links include any cellular network standards used to communicate among mobile devices, including, but not limited to, standards that qualify as 1G, 2G, 3G, or 4G. The network standards, if utilized, qualify as, for example, one or more generations of mobile telecommunication standards by fulfilling a specification or standards such as the specifications maintained by International Telecommunication Union. The 3G standards, if utilized, correspond to, for example, the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LIE Advanced, Mobile WiMAX, and WIMAX-Advanced. Cellular network standards may use various channel access methods, e.g., FDMA, TDMA, CDMA, or SDMA.

FIG. 4B is a diagram illustrating an exemplary process 400B of exchanging information among devices in the communication network 400A, including the mobile robot 100, the cloud computing system 406, and the mobile device 404. A cleaning mission may be initiated by pressing a button on the mobile robot 100 or may be scheduled for a future time or day. The user may select a set of rooms to be cleaned during the cleaning mission or may instruct the robot to clean all rooms. The user may also select a set of cleaning parameters to be used in each room during the cleaning mission.

During a cleaning mission, the mobile robot 100 tracks 410 its status, including its location, any operational events occurring during cleaning, and a time spent cleaning. The mobile robot 100 transmits 412 status data (e.g. one or more of location data, operational event data, time data) to a cloud computing system 406, which calculates 414, by a processor 442, time estimates for areas to be cleaned. For example, a time estimate could be calculated for a cleaning room by averaging the actual cleaning times for the room that have been gathered during multiple (e.g. two or more) prior cleaning missions for the room. The cloud computing system 406 transmits 416 time estimate data along with robot status data to a mobile device 404. The mobile device 404 presents 418, by a processor 444, the robot status data and time estimate data on a display. The robot status data and time estimate data may be presented on the display of the mobile device as any of a number of graphical representations editable mission timeline and/or a mapping interface. In some examples, the mobile robot 100 can communicate directly with the mobile device 404.

A user 402 views 420 the robot status data and time estimate data on the display and may input 422 new cleaning parameters or may manipulate the order or identity of rooms to be cleaned. The user 402, may, for example, delete rooms from a cleaning schedule of the mobile robot 100. In other instances, the user 402, may, for example, select an edge cleaning mode or a deep clean mode for a room to be cleaned. The display of the mobile device 404 is updates 424 as the user inputs changes to the cleaning parameters or cleaning schedule. For example, if the user changes the cleaning parameters from single pass cleaning to dual pass cleaning, the system will update the estimated time to provide an estimate based on the new parameters. In this example of single pass cleaning vs. dual pass cleaning, the estimate would be approximately doubled. In another example, if the user removes a room from the cleaning schedule, the total time estimate is decreased by approximately the time needed to clean the removed room. Based on the inputs from the user 402, the cloud computing system 406 calculates 426 time estimates for areas to be cleaned, which are then transmitted 428 (e.g. by a wireless transmission, by applying a protocol, by broadcasting a wireless transmission) back to the mobile device 404 and displayed. Additionally, data relating to the calculated 426 time estimates are transmitted 446 to a controller 430 of the robot. Based on the inputs from the user 402, which are received by the controller 430 of the mobile robot 100, the controller 430 generates 432 a command signal. The command signal commands the mobile robot 100 to execute 434 a behavior, which may be a cleaning behavior. As the cleaning behavior is executed, the controller continues to track 410 the robot's status, including its location, any operational events occurring during cleaning, and a time spent cleaning. In some instances, live updates relating to the robot's status may be additionally provided via push notifications to a mobile device or home electronic system (e.g. an interactive speaker system).

Upon executing 434 a behavior, the controller 430 checks 436 to see if the received command signal includes a command to complete the cleaning mission. If the command signal includes a command to complete the cleaning mission, the robot is commanded to return to its dock and upon return sends information to enable the cloud computing system 406 to generate 438 a mission summary which is transmitted to, and displayed 440 by, the mobile device 404. The mission summary may include a timeline and/or a map. The timeline may display, the rooms cleaned, a time spent cleaning each room, operational events tracked in each room, etc. The map may display the rooms cleaned, operational events tracked in each room, a type of cleaning (e.g. sweeping or mopping) performed in each room, etc.

Operations for the process 400B and other processes described herein can be executed in a distributed manner. For example, the cloud computing system 406, the mobile robot 100, and the mobile device 404 may execute one or more of the operations in concert with one another. Operations described as executed by one of the cloud computing system 406, the mobile robot 100, and the mobile device 404 are, in some implementations, executed at least in part by two or all of the cloud computing system 406, the mobile robot 100, and the mobile device 404.

### Examples of Robot Scheduling and Controlling System

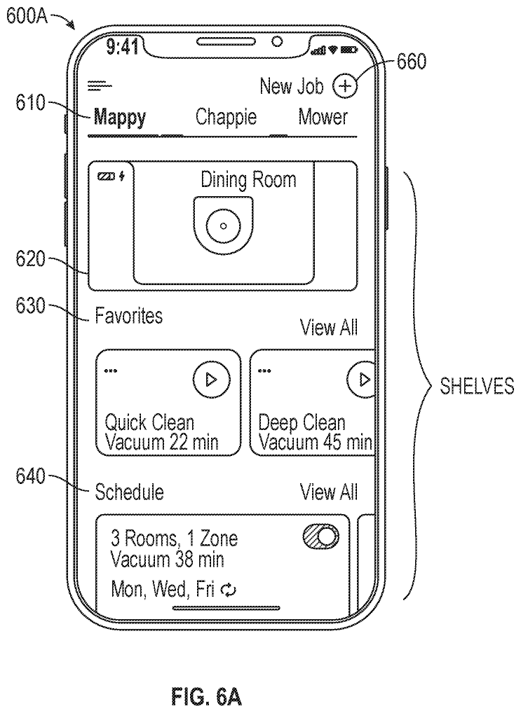

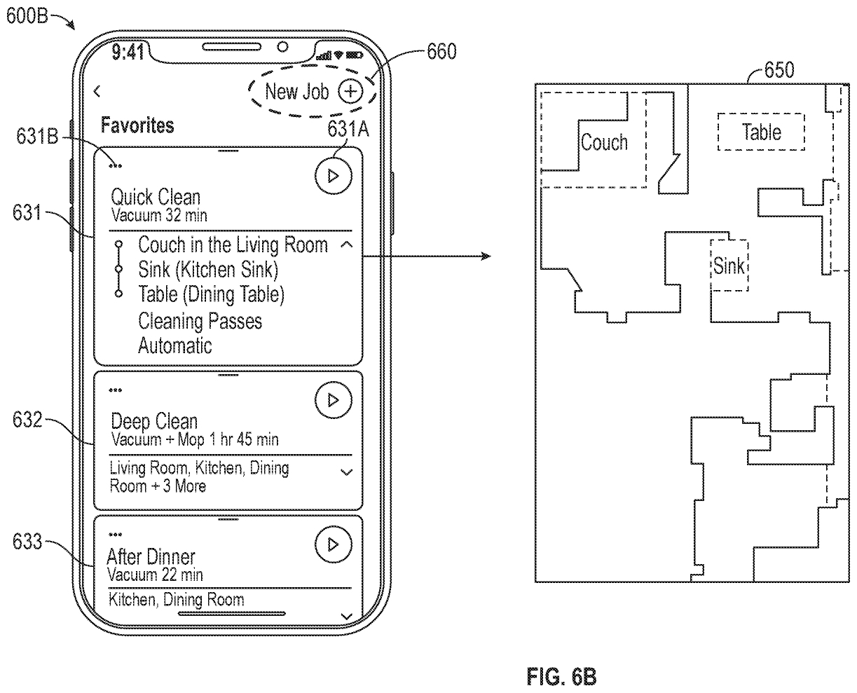

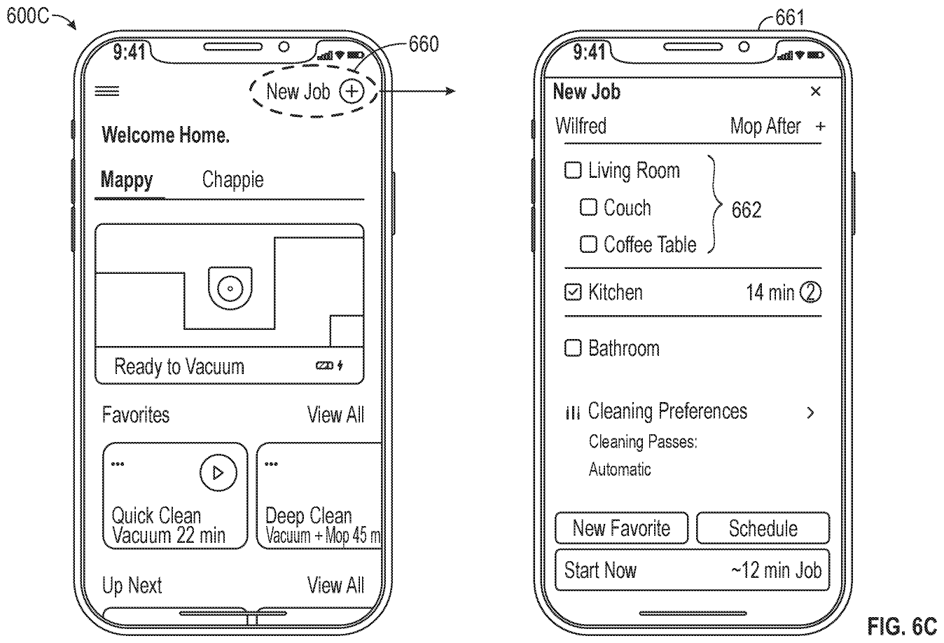

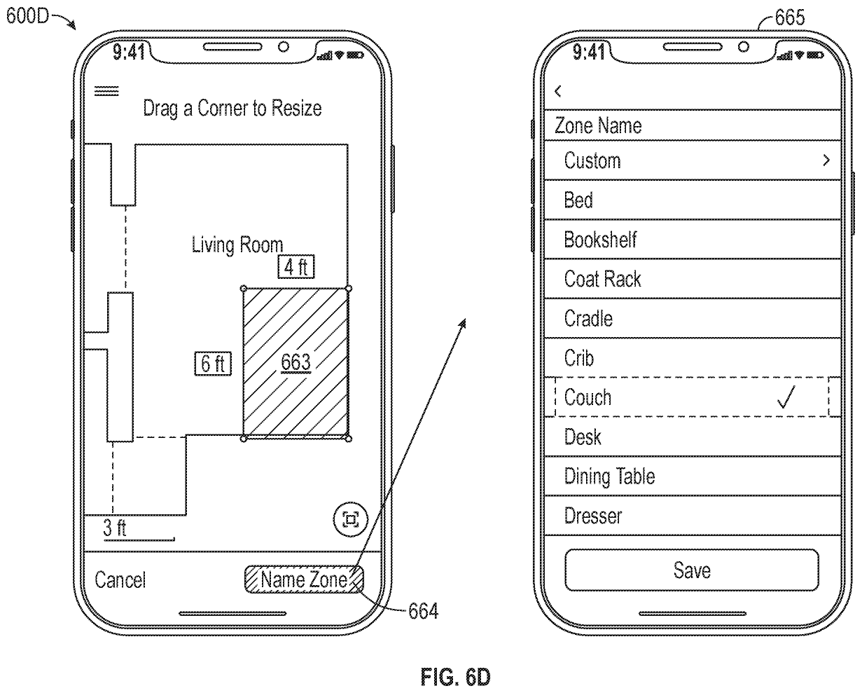

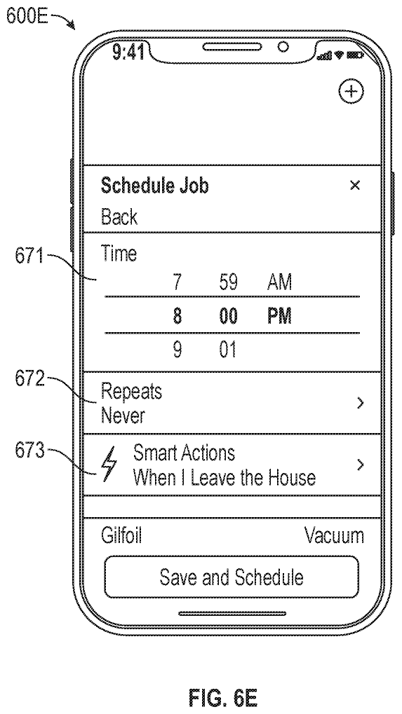

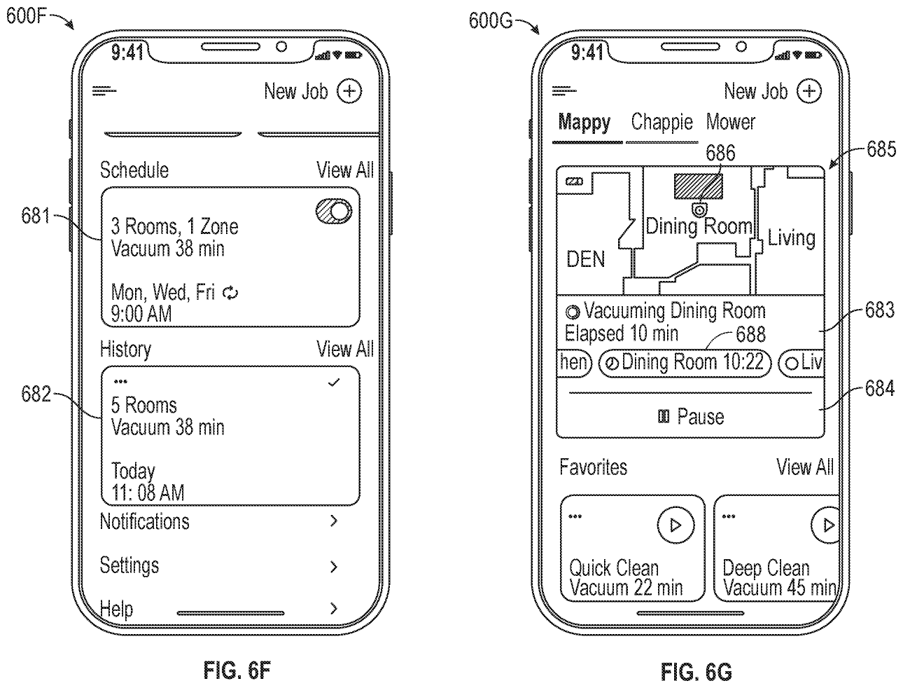

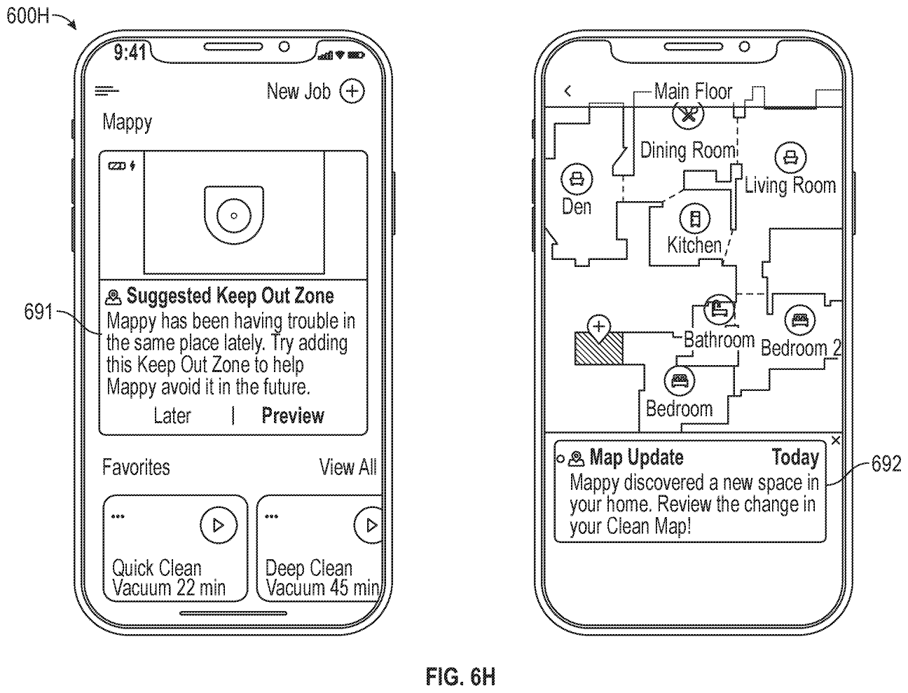

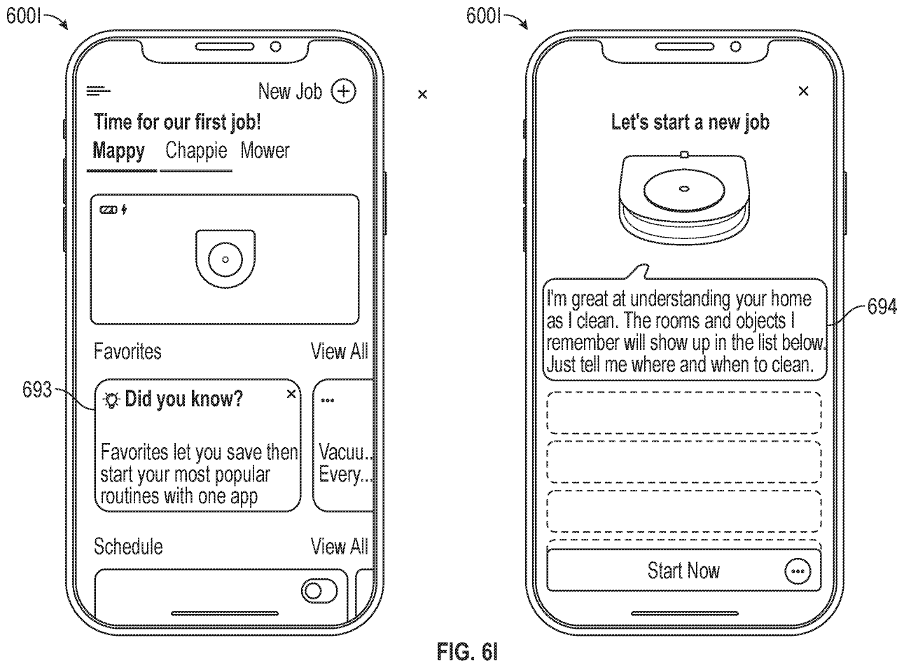

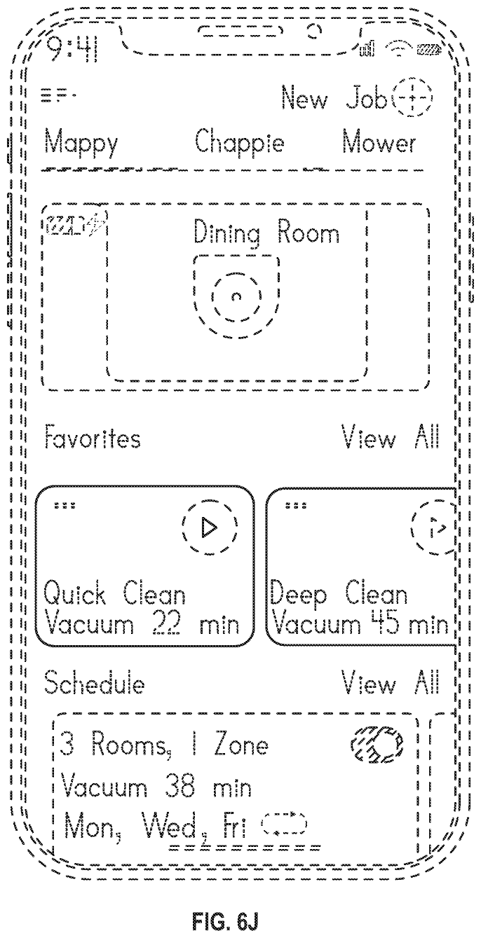

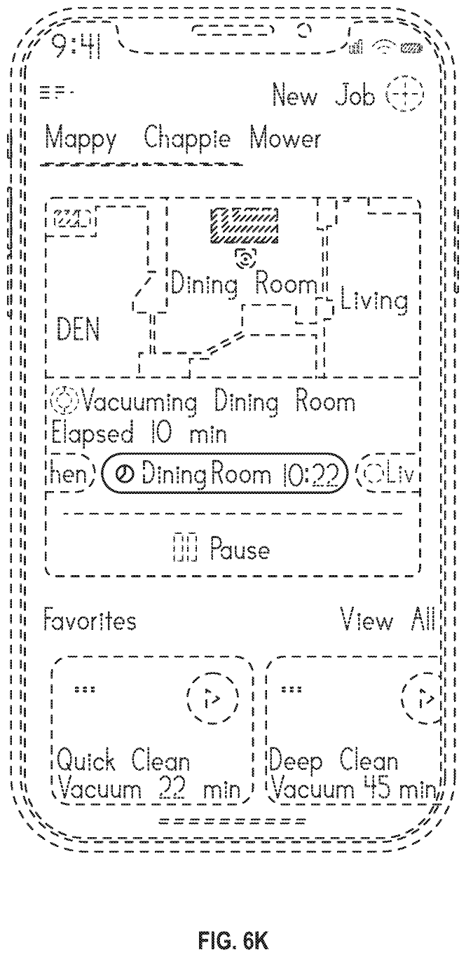

Various embodiments of systems, devices, and processes of scheduling and controlling a mobile robot based on contextual information and user experience are discussed in the following with reference to FIGS. 5 and 6A-6I. While this document makes reference to the mobile robot 100 that performs floor cleaning, the robot scheduling and controlling system and methods discussed herein can be used in robots designed for different applications, such as mopping, mowing, transporting, surveillance, among others. Additionally, while some components, modules, and operations may be described as being implemented in and performed by the mobile robot 100, by a user, by a computing device, or by another actor, these operations may, in some implementations, be performed by actors other than those described. For example, an operation performed by the mobile robot 100 can be, in some implementations, performed by the cloud computing system 406 or by another computing device (or devices). In other examples, an operation performed by the user can be performed by a computing device. In some implementations, the cloud computing system 406 does not perform any operations. Rather, other computing devices perform the operations described as being performed by the cloud computing system 406, and these computing devices can be in direct (or indirect) communication with one another and the mobile robot 100. In some implementations, the mobile robot 100 can perform, in addition to the operations described as being performed by the mobile robot 100, the operations described as being performed by the cloud computing system 406 or the mobile device 404. Other variations are possible. Furthermore, while the methods and processes described herein are described as including certain operations or sub-operations, in other implementations, one or more of these operation or sub-operations may be omitted, or additional operations or sub-operations may be added.

FIG. 5 is a diagram illustrating an example of a robot scheduling and controlling system 500 configured to generate and manage a mission routine for a mobile robot (e.g., the mobile robot 100), and control the mobile robot to execute the mission in accordance with the mission routine. The robot scheduling and controlling system 500, and methods of using the same, as described herein in accordance with various embodiments, may be used to control one or more mobile robots of various types, such as a mobile cleaning robot, a mobile mopping robot, a lawn mowing robot, or a space-monitoring robot.

The system 500 may include a sensor circuit 510, a user interface 520, a user behavior detector 530, a controller circuit 540, and a memory circuit 550. The system 500 can be implemented in one or more of the mobile robot 100, the mobile device 404, the autonomous robot 408, or the cloud computing system 406. In an example, some or all of the system 500 may be implemented in the mobile robot 100. For example, the sensor circuit 510 can be a part of the sensor system 320 of the robot control architecture 300 as shown in FIG. 3, the controller circuit 540 can be a part of the processor 324, and the memory circuit 550 can be a part of the memory unit 144 in the mobile robot 100. In another example, some or all of the system 500 can be implemented in a device separate from the mobile robot 100, such as a mobile device 404 (e.g., a smart phone or other mobile computing devices) communicatively coupled to the mobile robot 100. For example, the sensor circuit 510 and at least a portion of the user behavior detector 530 may be included the mobile robot 100. The user interface 520, the controller circuit 540, and the memory circuit 550 may be implemented in the mobile device 404. The controller circuit 540 may execute computer-readable instructions (e.g., a mobile application, or “app”) to perform mission scheduling and generating instructions for controlling the mobile robot 100. The mobile device 404 may be communicatively coupled to the mobile robot 100 via an intermediate system such as the cloud computing system 406, as illustrated in FIGS. 4A and 4B. Alternatively, the mobile device 404 may communication with the mobile robot 100 via a direct communication link without an intermediate device of system.

The sensor circuit 510 may include one or more sensors including, for example, optical sensors, cliff sensors, proximity sensors, bump sensors, imaging sensor, or obstacle detection sensors, among other sensors such as discussed above with reference to FIGS. 2A-2B and 3. Some of the sensors may sense obstacles (e.g., occupied regions such as walls) and pathways and other open spaces within the environment. The sensor circuit 510 may include an object detector 512 configured to detect an object in a robot environment, and recognize it as, for example, a door, or a clutter, a wall, a divider, a furniture (such as a table, a chair, a sofa, a couch, a bed, a desk, a dresser, a cupboard, a bookcase, etc.), or a furnishing element (e.g., appliances, rugs, curtains, paintings, drapes, lamps, cooking utensils, built-in ovens, ranges, dishwashers, etc.), among others.

The sensor circuit 510 may detect spatial, contextual, or other semantic information for the detected object. Examples of semantic information may include identity, location, physical attributes, or a state of the detected object, spatial relationship with other objects, among other characteristics of the detected object. For example, for a detected table, the sensor circuit 510 may identify a room or an area in the environment that accommodates the table (e.g., a kitchen). The spatial, contextual, or other semantic information may be associated with the object to create a semantic object (e.g., a kitchen table), which can be used to create an object-based cleaning mission routine, as to be discussed in the following.

The user interface 520, which may be implemented in a handheld computing device such as the mobile device 404, includes a user input 522 and a display 524. A user may use the user input 522 to create a mission routine 523. The mission routine 523 may include data representing an editable schedule for at least one mobile robot to performing one or more tasks. The editable schedule may include time or order for performing the cleaning tasks. In an example, the editable schedule may be represented by a timeline of tasks. The editable schedule can optionally include time estimates to complete the mission, or time estimates to complete a particular task in the mission. The user interface 520 may include UI controls that enable a user to create or modify the mission routine 523. some examples, the user input 522 may be configured to receive a user's voice command for creating or modifying a mission routine. The handheld computing device may include a speech recognition and dictation module to translate the user's voice command to device-readable instructions which are taken by the controller circuit 540 to create or modify a mission routine.

The display 524 may present information about the mission routine 523, progress of a mission routine that is being executed, information about robots in a home and their operating status, and a map with semantically annotated objects, among other information. The display 524 may also display UI controls that allow a user to manipulate the display of information, schedule and manage mission routines, and control the robot to execute a mission. Exemplary wireframe of the user interface 520 are discussed below, such as with reference to FIGS. 6A-6I.

The controller circuit 540, which is an example of the controller circuit 109, may interpret the mission routine 523 such as provided by a user via the user interface 520, and control at least one mobile robot to execute a mission in accordance with the mission routine 523. The controller circuit 540 may create and maintain a map including semantically annotated objects, and use such a map to schedule a mission and navigate the robot about the environment. In an example, the controller circuit 540 may be included in a handheld computing device, such as the mobile device 404. Alternatively, the controller circuit 540 may be at least partially included in a mobile robot, such as the mobile robot 100. The controller circuit 540 may be implemented as a part of a microprocessor circuit, which may be a dedicated processor such as a digital signal processor, application specific integrated circuit (ASIC), microprocessor, or other type of processor for processing information including physical activity information. Alternatively, the microprocessor circuit may be a processor that may receive and execute a set of instructions of performing the functions, methods, or techniques described herein.

The controller circuit 540 may include circuit sets comprising one or more other circuits or sub-circuits, such as a mission controller 542, a map management circuit 546, and a navigation controller 548. These circuits or modules may, alone or in combination, perform the functions, methods, or techniques described herein. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

The mission controller 542 may receive the mission routine 523 from the user interface 520. As discussed above, the mission routine 523 includes data representing an editable schedule, including at least one of time or order, for performing one or more tasks. In some examples, the mission routine 523 may represent a personalized mode of executing a mission routine. For a mobile cleaning robot, examples of a personalized cleaning mode may include a “standard clean”, a “deep clean”, a “quick clean”, a “spot clean”, or an “edge and corner clean”. Each of these mission routines defines respective rooms or floor surface areas to be cleaned and an associated cleaning pattern. For example, a standard clean routine may include a broader range of areas in the user's home environment, such as all the rooms, than a quick clean routine. A deep clean routine may include one or more repeated cleaning zones that include multiple passes over the same area, or for an extended period of cleaning time, or an application of a higher cleaning power. The personalized cleaning mode may be created or modified manually by the user such as via the user interface 520, or automatically triggered by an event such as detected by the user behavior detector 530. In an example, the controller circuit 540 may communicate with a light source to automatically adjust illumination of the target rooms or floor areas, and navigate the mobile cleaning robot to clean the target rooms or floor areas with the adjusted illumination. For example, for a “deep clean routine”, the controller circuit 540 may automatically trigger the light switch to increase illumination of the room or area to be cleaned, and the navigation controller 548 may navigate the mobile cleaning robot to the illuminated rooms or areas to perform cleaning in accordance with the deep clean routine.

The mission routine 523, such as a personalized cleaning mode (e.g., a deep clean mode), may include one or more tasks characterized by respective spatial or contextual information of an object in the environment, or one or more tasks characterized by a user's experience such as the use's behaviors or routine activities in association with the use of a room or an area in the environment. The mission controller 542 may include a mission interpreter 543 to extract from the mission routine 523 information about a location for the mission (e.g., rooms or area to be clean with respect to an object detected in the environment), time and/or order for executing the mission with respect to user experience, or a manner of cleaning the identified room or area. The mission interpreter 543 may interpret the mission routine using information of the objects detected by the object detector 512 and semantics of the object, user behaviors detected by the user behavior detector 530, or map generated and maintained by the map management circuit 546.

Compared to location-and-map based mission, the contextual and user experience-based mission routine is architected to add a user's personalized content. As the contextual and user experience--based mission routine is more consistent with natural language description of a mission, it enables more intuitive communication between the user and the robot. allowing the mobile robot to execute the mission in a commonly understandable fashion between the user and the robot. Additionally, the inclusion of the contextual information and user experience in mission description enriches the content of a mission routine, adds more intelligence to robot behavior, and enhances user experience of personalized control of the mobile robot. Examples of contextual and user experience-based mission routines, and interpretation of mission routine by the mission interpreter 543, are discussed below.

The mission monitor 544 may monitor the progress of a mission. In an example, the mission monitor 544 may generate a mission status report showing the completed tasks (e.g., rooms that have cleaned) and tasks remaining to be performed (e.g., rooms to be cleaned according to the mission routine). In an example, the mission status report may include an estimate of time for completing the mission, elapsed time for the mission, time remaining for the mission, an estimate of time for completing a task in a mission, elapsed time for a task in the mission, or time remaining for a task in the mission. The estimation of time for completing the entire mission or a task in the mission can be based on a characteristic of the environment, such as approximate square footage or area measurement of the space to be cleaned, number of rooms to be traversed, debris status, or a level of dirtiness of the one or more target areas, such as detected by be sensor circuit 510. Additionally or alternatively, the estimation of time may be based on historical mission completion time, or a test run through all rooms for purposes of calculating time estimates.

The mission optimizer 545 may pause, abort, or modify a mission routine or a task therein such in response to a user input or a trigger event. The mission modification may be carried out during the execution of the mission routine. Examples of mission modification may include adding a new task to the mission, removing an existing from the mission, or prioritizing one or more tasks in the mission (e.g., change the order of the tasks, such as cleaning certain “hotspots” such as dirtier areas before other areas in a home). The trigger event that causes the mission optimizer 545 to modify time or order of the tasks in a mission can be a specific type of user behavior, such as room occupancy indicating a presence or absence of a person in a room. The room occupancy may be detected by the behavior detector 530, such as communicatively coupled to a security camera in the room. Alternatively, the room occupancy may be detected by the object detector 512 coupled to a sensor included in a mobile robot. To execute a user experience-based mission routine or task such as “dean the living room when it is unoccupied”, in response to a detection of an occupied room, the controller circuit 540 may pause the mission, or modify the mission routine, such as by rescheduling or postponing the task scheduled to be performed in the occupied room until it is no long occupied, or as instructed by a user.

Another example of the user behavior includes user engagement in an audio-sensitive event, such as on a phone call, watching TV, listening to music, or having a conversation. The audio-sensitive event may be detected by the behavior detector 530, such as communicatively coupled to an audio sensor. To execute a user experience-based mission routine or task such as “don't clean when I'm watching TV.” The controller circuit 540 may pause the mission, or modify the mission routine such as by rescheduling or postponing the task that interferes with the audio-sensitive event until the audio-sensitive event is over, or as instructed by a user.

In some examples, the mission optimizer 545 may receive a time allocation for completing a mission, and prioritize one or more tasks in the mission routine based on the time allocation. To execute a user experience-based mission routine or task such as “clean as many rooms as possible within next hour”, the mission monitor 544 may estimate time for completing individual tasks in the mission (e.g., time required for cleaning individual rooms), such as based on room size, room dirtiness level, or historical mission or task completion time. The optimizer 545 may modify the mission routine by identifying and prioritizing those tasks that can be completed within the allocated time.

The map management circuit 546 may generate and maintain a map of the environment or a portion thereof. In an example, the map management circuit 546 may generate a semantically annotated object by associating an object, such as detected by the object detector 512, with semantic information, such as spatial or contextual information. Examples of the semantic information may include location, an identity, or a state of an object in the environment, or constraints of spatial relationship between objects, among other object or inter-object characteristics. The semantically annotated object may be graphically displayed on the map, thereby creating a semantic map. The semantic map may be used for mission control by the mission controller 542, or for robot navigation control by the navigation controller 548. The semantic map may be stored in the memory circuit 550.

Semantic annotations may be added for an object algorithmically. In an example, the map management circuit 546 may employ SLAM techniques to detect, classify, or identify an object, determine a state or other characteristics of an object using sensor data (e.g., image data, infrared sensor data, or the like). Other techniques for feature extraction and object identification may be used, such as geometry algorithms, heuristics, or machine learning algorithms to infer semantics from the sensor data. For example, the map management circuit 546 may apply image detection or classification algorithms to recognize an object of a particular type, or analyze the images of the object to determine a state of the object (e.g., a door being open or closed, or locked or unlocked). Alternatively or additionally, semantic annotations may be added by a user via the user interface 520. Identification, attributes, state, among other characteristics and constraints, can be manually added to the semantic map and associated with an object by a user.

The navigation controller 548 may navigate the mobile robot to conduct a mission in accordance with the mission routine. In an example, the mission routine may include a sequence of rooms or floor surface areas to be cleaned by a mobile cleaning robot. The mobile cleaning robots may have a vacuum assembly and uses suction to ingest debris as the mobile cleaning robot traverses the floor surface. in another example, the mission routine may include a sequence of rooms or floor surface areas to be mopped by a mobile mopping robot. The mobile mopping robot may have a cleaning pad for wiping or scrubbing the floor surface. In some examples, the mission routine may include tasks scheduled to be executed by two mobile robots sequentially, intertwined, in parallel, or in another specified order or pattern. For example, the navigation controller 548 may navigate a mobile cleaning robot to vacuum a room, and navigate a mobile mopping robot to mop the room that has been vacuumed.

### Examples of Contextual or User-Experience-Based Mission Routines

In an example, the mission routine may include one or more cleaning tasks characterized by, or made reference to, spatial or contextual information of an object in the environment, such as detected by the object detector 512. In contrast to a room-based cleaning mission that specifies a particular room or area (e.g., as shown on a map) to be cleaned by the mobile cleaning robot, an object-based mission may include a task that associates an area to be cleaned with an object in that area, such as “clean under the dining table”, “clean along the kickboard in the kitchen”, “clean near the kitchen stove”, “clean under the living room couch”, or “clean the cabinets area of the kitchen sink”, etc. As discussed above with reference to FIG. 5, the sensor circuit 510 may detect the object in the environment and the spatial and contextual information association with the object. The controller circuit 540 may create a semantically annotated object by establishing an association between the detected object and the spatial or contextual information, such as using a map created and stored in the memory circuit 550. The mission interpreter 543 may interpret the mission routine to determine the target cleaning area with respect to the detected object, and navigate the mobile cleaning robot to conduct the cleaning mission.

In some examples, the object referenced in a mission routine may include debris status in a room or an area. An exemplary mission routine may include “clean the dirty areas.” The object detector 512 may detect debris status, or a level of dirtiness. The controller circuit 540 may prioritize cleaning of the one or more rooms or floor surface areas by respective dirtiness levels. For example, a mission routine may include a first area having a higher level of dirtiness than a second area, which has a higher level of dirtiness than a third area. The controller circuit 540 may prioritize the mission tasks such that the first area gets cleaned first, following by the second area, followed by the third area. The controller circuit 540 may additionally or alternatively prioritize cleaning of the one or more rooms or floor surface areas by respective debris distributions in those rooms or areas. A room with more widely spread debris (i.e., a higher spatial distribution) has a lower priority in the mission routine, and gets cleaned later, than a room with more spatially concentrated debris.

In an example, the mission routine may be characterized by, or made reference to, user experience of using a room or an object therein. The user experience represents a personalized manner of interaction with a room or an object therein. Examples of the user experience may include a user's time, pattern, frequency, or preference of using an room or an area in the environment, or a user's behavior or daily routine associated with use, non-use, or a manner of use of a room or an area in the environment. In an example, the experience-based mission routine may include an “after dinner clean routine” that defines cleaning tasks with regard to areas likely to be affected by preparation and serving of dinner, such as a kitchen floor and floor areas around the dining table. In another example, the experience-based mission routine may include an “after shower clean routine” that defines cleaning tasks with regard to areas likely to be affected by a user taking a shower, such as a bathroom floor. In some examples, the user experience-based mission routine may be defined with respect to user's activity or daily routine. For example, the experience-based mission routine may include “clean all rooms after I leave the house”, or “clean the living room before I get home”.

Execution of the user experience-based mission routine may be activated or modified manually by a user, such as via the user interface 520. For example, a user may manually initiate the “after dinner clean routine” after the dinner, or the “after shower clean routine” after the shower. Examples of the user interface 520 and UI controls for creating, activating, monitoring, or modifying a mission routine are discussed below, such as with reference to FIGS. 6A-6I. Additionally or alternatively, the user experience-based mission routine may be automatically activated in response to a detection of user behavior, such as by the user behavior detector 530. As illustrated in FIG. 5, the user behavior detector 530 may be configured to detect user behavior associated with the use, non-use, or a manner of use of a room or an area in the environment. In an example, the user behavior detector 530 may be communicatively coupled to one or more sensors including, for example, ambulatory sensors (e.g., the sensors included in the mobile robot, such as a camera), or stationary sensors positioned in rooms or appliances, such as in a smart home ecosystem. For example, the controller circuit 540 may activate the “after diner clean routine” in response to a detection of a dishwasher being turned on, such as via a sensor on the dishwasher. In another example, the controller circuit 540 may activate the “clean all rooms after I leave the house” in response to a detection of locking of an entry door or closing of a garage door, such as via a smart door lock sensor. In another example, the user behavior detector 530 may request and establish a communication with to a user's digital calendar (such as one stored in the user's mobile phone), and retrieve user daily schedule therefrom. The controller circuit 540 may activate or modify the mission based on the schedules of calendar events. For example, a calendar event of a doctor's appointment at a particular time slot may indicate the user's absence from home, and the controller circuit 540 may active the mission of “clean all rooms after I leave the house” during the time of that calendar event.

### Examples of A User Interface for Mission Scheduling and Robot Control

FIGS. 6A-6I are, by way of example and not limitation, wireframes of a user interface, such as screen framework of the user interface 520 of the system 500, for maintaining a cleaning mission routine and controlling a mobile robot to execute the cleaning mission in an environment. The user interface may be a part of a handheld computing device, such as a smart phone, a cellular phone, a personal digital assistant, a laptop computer, a tablet, a smart watch, or other portable computing device capable of transmitting and receiving signals related to a robot cleaning mission. In an example, the handheld computing device is the mobile device 404. The user interface as described herein can be configured to present, on a display (such as the display 524), information about one or more robots in a user's home and their respective operating status, one or more editable mission routines (e.g., a cleaning mission), a progress of a mission being executed. In some examples, a map of the environment or a portion thereof may be displayed along with objects in the environment. The user interface may also receive user instructions, such as via the user input 522, for creating or modifying a mission routine, managing a map, and controlling the robot navigation and mission execution.

FIG. 6A illustrates an example of a user interface 600A that displays an at-a-glance view of mobile robots in a user's home and mission routines created for one or more of the mobile robots. The at-a-glance view can progressively disclose relevant information to the user based on historical user-interactions with the robot, prior usage of the robot, or based on the context of a mission, such as the robot that is active in a mission, nature of the mission, and progress of a mission, etc.

The user interface 600A may display a robot menu 610 including active mobile robots communicatively linked to the handheld computing device. The communication between the mobile robots and the handheld computing device can be direct communication, or via an intermediate system such as the cloud computing system 406, as discussed above with reference to FIGS. 4A and 4B. Through a single user interface 600A, a user may coordinate the behaviors of multiple robots. The user interface 600A may include one or more user interface (UI) controls (e.g., buttons, checkboxes, dropdown lists, list boxes, sliders, links, tabstrips, charts, windows, among others) that allow a user to fulfill various functions of mission scheduling and robot control. For example, a user may add a new mobile robot to the robot menu 610 such as by establishing a communication between the handheld computing device and the new mobile robot, or remove an existing mobile robot from the robot menu 610 such as by disconnecting a communication between the handheld computing device and the existing active mobile robot. The mobile robots included in the robot menu 610 (such as “Mappy”, “Chappie”, and “Mower” shown in FIG. 6A) may be of different types, such as cleaning (e.g., vacuuming or sweeping) robots, mopping robots, or mowing robots. In an example, two or more robots of the same type (e.g., cleaning robots) may be cataloged in the robot menu 610. A user may use the UI controls, or a finger touch on a touch-screen of the user interface 600A, to select one or more mobile robots, or switch between different mobile robots included in the robot menu 610.

For a mobile robot selected from on the menu 610 (e.g., “Mappy” robot as shown), robot information and mission routine associated with the selected robot(s), among other information, may be displayed in separate categories, also referred to as shelves, on the user interface 600A. By way of example and not limitation, the user interface 600A may display a robot information shelf 620, a mission routine shelf 630, and a mission status shelf 640. The shelves may be arranged in a list or in separate pages, and accessible via one or more UI navigational controls such as a slider, pagination, breadcrumbs, tags, or icons, among others. The robot information shelf 620 may include a graphical representation of the selected robot(s), an operating status indicator indicating a current status such as battery status (e.g., remaining battery life) and readiness for a mission, and educational and user-coaching messages about the use of the robot. In some examples, the robot information shelf 620 may display a map of the environment including an indication of location and motion of the mobile robot active in a mission. The mission routine shelf 630 may display information about one or more mission routines created by the user, such as in accordance with various examples of the mission routine 523 as discussed above. The mission routines include a user's “favorites”, which can be saved, personalized common routines performed by one or more mobile robots. The favorites may be arranged in a list, or arranged side by side. The user may scroll across the favorites and select a mission routine for execution or edition using the UI controls. In various examples, a user may use UI controls to rearrange the order of the favorites displayed on the user interface 600A. Additionally or alternatively, the favorites may be automatically sorted in a particular order, such as an ascending order of approximate mission execution time associated therewith. This makes it convenient for a user to quickly select a mission that fits the user's schedule and time allocation. In some examples, the favorites may be identified (e.g., labeled) as selectable or non-selectable routines based on the user's schedule or time allocation for executing a mission.

In an example, the favorites may include mission routines characterized by different cleaning modes, such as a “Standard Clean” mission, a “Deep Clean” mission, a “Quick Clean” mission, a “Spot Clean” mission, or an “Edge and Corner Clean” mission. In another example, the favorites may include one or more context-based mission routines. A context-based mission routine may include one or more cleaning tasks characterized by, or made reference to, spatial or contextual information of an object in the environment. For example, a context-based cleaning mission may refer to rooms or floor surface areas with reference to a furniture or a furnishing, such as “under the living room couch”, “under the dining table”, “along the kickboard in the kitchen”, “near the kitchen stove”, or “the cabinets area of the kitchen sink”. In another example, a context-based cleaning mission may include tasks with reference to debris status, such as “the dirty areas in the room”. In yet another example, the favorite routines may include a user experience-based mission routine that associates one or more tasks in the mission with a user's personalized time, pattern, frequency, or preference of interacting with a room or an object therein, or a user's behavior associated with use, non-use, or a manner of use of a room or an area in the environment. Examples of the experience-based mission routines may include “after dinner clean routine”, “after shower clean routine”, “clean the rooms when I leave the house”, or “clean the rooms before I get home”, among others, as discussed above with reference to FIG. 5.

A mission routine may include an editable schedule, such as time or order, for performing the one or more tasks included in the mission routine. Referring now to FIG. 6B, the user interface 600B illustrates a mission routine shelf 630 that includes a “Quick Clean” routine 631, a “Deep Clean” routine 632, and an “After Dinner” routine 633. A mission routine, such as the Quick Routine 631, may include a first affordance 631A (such as represented by a play button) to execute that routine, and a second affordance 631B (such as represented by an ellipsis symbol) to edit the mission routine. A user may use a single tap or click on the play button to execute the tasks included in the mission routine, or use a single tap or click on the ellipsis symbol to edit the mission routine. As illustrated therein, the “Quick Clean” routine 631 comprises a sequence of tasks characterized by, or in reference to, objects including a couch in the living room, a kitchen sink, and a dining table. The objects may be associated with respective rooms or areas in the environment where the objects are located. As illustrated in FIG. 6B, the object-room (or object-area) association may be represented by descriptive texts. Additionally or alternatively, the object-room or object-area) association may be represented by a graph. The objects may be displayed as icons or text labels. In an example, the object-room (or object-area) association may be represented by an indented list of object labels below the associated room label, such as the indented list 662 as shown in FIG. 6C. The tasks included in a mission routine (such as in reference to different objects) may be arranged in a “playlist”. In an example, a user may use the UI controls to access a map of the environment, or a map portion 650 that includes objects referenced by the “Quick Clean” routine 631 (e.g., the couch, the sink, and the table). In an example, the map portion 650 can be a semantic map that includes semantic annotations (e.g., locations, identities, and dimensions) of the objects referenced by the “Quick Clean” routine 631.

FIGS. 6C, 6D, and 6E are wireframes of a user interface for creating and maintaining a mission routine. A mission routine comprises one or more tasks and a schedule (e.g., time and/or order) for performing said one or more tasks. Referring now to FIG. 6C, a user may click on or tap a “New Job” button 660 on the user interface 600C, which links to a job creation page 661 that displays identifiers of rooms or areas in the environment that may be selected to add to a new mission or an existing mission. The rooms and the areas may have respectively pre-defined locations and dimensions in the environment. Alternatively or additionally, location and/or dimension of a room or an area may be defined or modified on-demand, such as with reference to an object therein. One or more objects associated with a room or area may be displayed on the job creation page 661. The rooms, areas, and the associated objects may be displayed as icons or text labels. In some examples, the rooms or areas may be characterized by, or made reference to, spatial or contextual information of an object, such as “under the dining table”, “along the kickboard in the kitchen”, “near the kitchen stove”, “under the living room couch”, or “cabinets area of the kitchen sink”. The association between the object and the room or area that accommodates the object may be represented graphically, such as by an indented list 662 of object labels (e.g., “couch” and “coffee table”) below the associated room label (e.g., “Living room”). The indented list allows for easy understanding of the association, and the hierarchical relationship between the room and the objects. A user may use the UI controls to select a room (e.g., “kitchen”), or an area characterized by an object (e.g., “living room couch”), and add it to the mission routine. In an example, the user may use personalized vocabulary to name the selected room, area, or object. In some examples, a user can add a spatial or contextual identifier (e. g., “under”, “around”, “next to”) after selecting an object, a room, or an area. For example, after selecting the kitchen table, the user can select from a pre-generated list a contextual identifier “under” for the kitchen table, and create a mission or a task therein using the contextually characterized object “under the kitchen table”.

In some examples, the handheld computing device in which the user interface resides may include an input device (e.g., the user input 522) configured to receive a voice command from a user for creating or modifying a mission routine or a task therein. The handheld device may include a speech recognition and dictation module configured to translate the user's voice command to device-readable instructions. The mission interpreter 543 may use the translated instructions to create or modify a mission routine.

In addition to or in lieu of a pre-defined room, area, or object, a user may create a region from a map to be included in a mission. Referring now to FIG. 6D, a user may use draw a region 663 on the map shown on the user interface 600D using on-screen drawing UI controls (e.g., a pencil element), or a fingertip moving across a touch screen of the user interface 600D. Other on-screen elements may be provided to facilitate creation and manipulation of a region, including, for example, an eraser, a move element, a rotate element, or a resize element, among others.

The region 663 may represent a room, an area, or an object in the environment. The region 663 may have a specific size, shape, and location, such as a polygon within an existing room or area of the environment. A user may click on or tap a UI control button 664 (“Name Zone”), which links to a page of pre-generated lexicon 665. In the example shown here, the region 663 represents a piece of furniture (e.g., a couch) within a pre-defined room (“Living Room”). The user may pick, from a pre-generated list of furniture names, a proper name (“couch”) for the region 663. Alternatively, the user may provide a personalized vocabulary or an identifier for the region 663. In addition to the object identity, other semantic information of the object may be created similarly. The object thus created, also known as a semantic object or semantically annotated object, may be added to the map, and used for mission scheduling and robot control.

The new job creation as illustrated in FIGS. 6C and 6D may also be used to modify an existing mission, such as adding a new task to the mission, removing a task from the mission, or changing the order of the tasks, among others. For example, for a “Quick Clean” routine on the mission routine shelf 630 (as shown in FIG. 6B), a user may click on or tap the “New Job” button 660 to modify the “Quick Clean” routine, such as adding a new object “dresser” to the “Quick Clean” routine, or removing an existing object “table” from the “Quick Clean” routine. In another example, a user can select or define an object or a region in the map, and insert such an object or region into an existing mission.

FIG. 6E is a wireframe of a user interface 600E for scheduling a task for a mission routine. A user may use UI controls on the user interface 600E to select or enter time 671 and repeating pattern 672 for a task. In some examples, the schedule for a task may be characterized by, or with reference to, user experience or behavior associated with use, non-use, or a manner of use of a room or an area in the environment. FIG. GE shows an example of a user experience-based task 673, “when I leave the house”. A mission routine that includes one or more experience-based tasks is known as an experience-based mission routine. As discussed above, execution of a user experience-based mission or a task therein may be triggered by a sensor, such as one in a smart home ecosystem, that is configured to detect user behavior. For example, the cleaning task scheduled for “when I leave the house” may be automatically triggered by a detection of closing of an entry door or a garage door, such as by using a door lock sensor in a smart home ecosystem.

Referring now back to FIG. 6A, the at-a-glance view on the user interface 600A may include a mission status shelf 640 that displays the progress of a mission or a task therein that is being executed. FIGS. 6F and 6G illustrate examples of the mission status shelf 640. FIG. 6F is a wireframe of a user interface 600F that presents information about a mission routine, including tasks included therein and a schedule for the tasks (e.g., time and/or order for performing the tasks). The tasks may be textually or graphically presented such as in a list format. The user interface 600F may display an ongoing mission being executed. In some example, the user interface 600F may additionally or alternatively display information about a future mission routine 681 scheduled to be executed, or a historical mission 682 that has been completed.

FIG. 6G is a wireframe of a user interface 600G for monitoring the progress of an ongoing mission routine. The progress may be presented in a format of a mission status report 683 that includes completed task(s), task currently being performed, and task(s) to be completed, in a present mission routine. Each task may be represented by an icon or label. In an example, the icon or label representing a completed task may be displayed in a different shape, color, outline, shading, etc. from the icon or label representing the task being performed and the task that remains to be performed.

The user interface 600G may include a graphical representation of a map 685 of the environment, such as one representing a floorplan of an area where the mission is to be performed (e.g., rooms to be cleaned). The map may be split into rooms or areas. In an example as illustrated in FIG. 6G, the rooms and areas that have been cleaned (the completed tasks) may be displayed in a different color, outline, fill pattern, etc. from the room currently being cleaned and the rooms that remain to be cleaned. The map 685 may also include a robot icon 686 representing the location of the mobile robot in a mission. The robot icon 686 may be animated within the map 685 as the mobile robot moves across the rooms and areas to be cleaned according the mission routine. As the mobile robot moves, information relating to the mobile robot position and cleaning status may be transmitted to the handheld computing device via the communication link therebetween, optionally further via the cloud computing system 406.

The mission status report 683 may include one or more of an estimate of time for completing the mission, elapsed time for the mission, time remaining for the mission, an estimate of time for completing a task in a mission, elapsed time for a task in the mission, or time remaining for a task in the mission. The progress of the mission or a task may be represented by text or number labels (e.g., “time remaining 00:18”), or icons or graphs such as a linear or circular progress bar, a progress chart, a progress donut, among other informational UI components. As discussed above with reference to FIG. 5, the estimation of time for completing a mission or a task therein can be based on a characteristic of the environment, such as approximate square footage of the space to be cleaned, debris status, a level of dirtiness of the one or more target areas, or historical mission completion time, or a test run through all rooms for purposes of calculating time estimates.

The user interface 600G may include UI controls 684 that enable a user to perform mission or task control while the mission is being executed. For example, through the user interface 600g, a user may pause or abort the entire mission or a task therein, add a task to the mission, remove a task from the mission, reschedule a task, or prioritize a task (such as by changing the order of the tasks) in the mission.

FIG. 6H is a wireframe of a user interface 600H for creating a map of the environment, or managing an existing map stored in the memory. A user may use UI controls to generate or update a map. For example, for a cleaning mission, the user may add, remove, or modify one or more of a cleaning zone, a keep-out zone, or a repeated cleaning zone. In some examples, the map may include semantic information about one or more objects in the environment. As discussed above with reference to FIG. 5, the objects may be detected by the sensor circuit 510. Alternatively, a user may manually identify or create (e.g., draw on a map) an object. In various examples, semantic information, such as location, an identity, or a state of an object in the environment, or constraints of spatial relationship between objects, among other object or inter-object characteristics, may be associated with the object and added to the map. A map that contains semantic information of objects is also referred to as a semantic map. The semantic map may be used to schedule a mission and to navigate the mobile robot across the environment to execute the mission.

The user interface 600H may display messages about objects detected or new areas discovered by the mobile robot while navigating the environment. In some examples, system-generated recommendations may be presented to the user in response to the detection of new objects or discovery of new areas. By way of example, FIG. 6H shows a message or dialog box 691 that prompts the user to create a keep-out zone in a target region based on robot's traversal experience in the region. In another example, a message or dialog box 692 informs the user about a new space discovered when executing a mission, and prompts the user to update the map to recognize and semantically annotate the newly discovered space. A user may choose to review the map, defer the review, make changes to the map, or refuse to mate any changes to the map, via one or more UI controls on the user interface 600H.

In an example, a user may make changes to the map such as by drawing a line to split one room into two separate rooms, and providing semantic annotations (e.g., identities such as a name or an icon) for the split rooms. In an example, the user may select a boundary between rooms on the map to merge rooms together into one room. The user may be prompted to provide semantic annotations identities such as a name or an icon) for the merged room.

In some examples, various messages may be progressively disclosed to the user based on the context and user experience with the mission scheduling and robot control. For example, coaching or educational messages (e.g., hints and tips, or spotlight messaging), recommendations, interactive trouble-shooting guides, or user survey, reminders to perform maintenance, etc. may be displayed on the user interface to enhance user experience and improve the performance of robot scheduling and controlling. Referring to FIG. 6I, a user interface 600I may display a Spotlight Messaging field with messages on various features of mission creation and robot control, such as the contextual and user experience-based favorite routines 693, or messages about the objects and rooms that the robot has detected and stored in the map 694, and prompting a user to select a cleaning routine, among others. The Spotlight Messaging may guide a user through all stages of mission creation, management, and robot control.

FIG. 6J illustrates an example of a UI design for a handheld device showing selectable mission routines on a display screen. The mission routines are arranged in a mission routine shelf, also referred to as a user's “favorites”, as discussed above with reference to FIG. 6A. A mission routine, such as the Quick Clean routine as shown, may include a first affordance such as represented by a play button to execute that routine, and a second affordance such as represented by an ellipsis symbol to edit the mission routine. A user may use a single tap or click on the play button to execute the tasks included in the mission routine, or use a single tap or click on the ellipsis symbol to edit the mission routine. The broken lines in FIG. 6J show portions of the user interface that form no part of the claimed design.

FIG. 6K illustrates an example of a UI design for a handheld device showing the progress of an ongoing mission routine on a display screen. The completed task(s), task currently being performed, and task(s) to be completed included in the present mission routine can be arranged and displayed in a mission status report, as discussed above with reference to FIG. 6G. In the example as shown in FIG. 6K, the mission routine has progressed to a dining room cleaning task. Associated with the dining room cleaning task is a display of one or more of an estimate of time for completing the present task, elapsed time for the present task in the mission, or time remaining for the present task. The progress of a task may be represented by text or number labels, or icons or graphs such as a linear or circular progress bar, a progress chart, a progress donut, among other informational UI components. The broken lines in FIG. 6K show portions of the user interface that form no part of the claimed design.

### Examples of Methods of Generating and Managing a Semantic Map

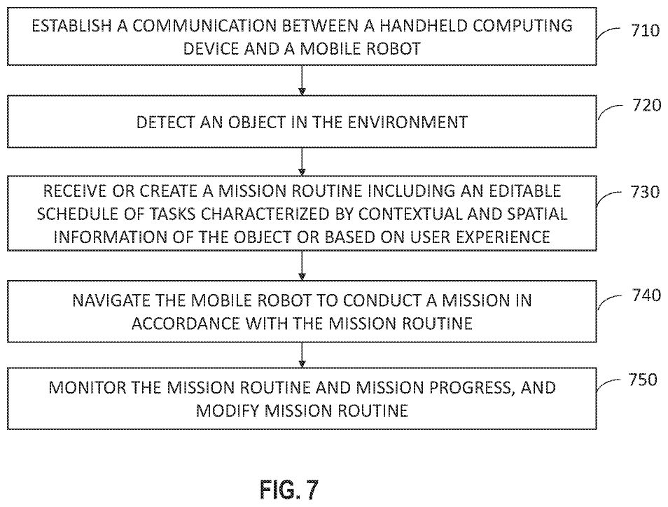

FIG. 7 is a flow diagram 700 illustrating an example of a method of generating and managing a contextual and user experience-based mission routine, and controlling a mobile robot to execute a mission in an environment in accordance with the mission routine. The method 700 can be implemented in, and executed by, the robot scheduling and controlling system 500. The method 700 may be used for scheduling and controlling one or more mobile robots of various types, such as a mobile cleaning robot, a mobile mopping robot, a lawn mowing robot, or a space-monitoring robot.

The method 700 commences at step 710 to establish a communication between a handheld computing device (such as the mobile device 404) and a mobile robot (such as the mobile robot 100). The handheld computing device can execute device-readable instructions implemented therein, such as a mobile application. The communication between the handheld computing device and the mobile robot may be via an intermediate system such as the cloud computing system 406, or via a direct communication link without an intermediate device of system. In an example, the handheld computing device may include a user interface (UI) configured to display robot information and its operating status. A user may manage a suite of active mobile robots and coordinate their activities in a mission. In an example, a user may use UI controls to add a new mobile robot such as by establishing a communication between the handheld computing device and the new mobile robot, or remove an existing mobile robot such as by disconnecting a communication between the handheld computing device and the existing mobile robot.

At 720, an object may be detected in the environment, such as using the object detector 512 coupled to a sensor included in a mobile robot. The detection of the object includes recognizing an object as, for example, a door, or a clutter, a wall, a divider, a furniture (such as a table, a chair, a sofa, a couch, a bed, a desk, a dresser, a cupboard, a bookcase, etc.), or a furnishing element (e.g., appliances, rugs, curtains, paintings, drapes, lamps, cooking utensils, built-in ovens, ranges, dishwashers, etc.), among others. The detected object may be associated semantic information, such as spatial or contextual information, to create a semantically annotated object. Examples of the semantic information may include location, an identity, or a state of an object in the environment, or constraints of spatial relationship between objects, among other object or inter-object characteristics. Semantic annotations may be added for object algorithmically, such as via the map management circuit 546. Alternatively, semantic annotations may be added by a user via the user interface 520.

At 730, a mission routine may be received. In an example, a user may create a mission routine using the handheld computing device, as illustrated in FIGS. 6B-6E. The mission routine includes data representing an editable schedule of one or more tasks characterized by respective contextual or spatial information of the object, or one or more tasks characterized by a user's experience such as the use's behaviors or routine activities in association with the use of a room or an area in the environment. Examples of object-based mission may include a task that associates an area to be cleaned with an object in that area, such as “clean under the dining table”, “clean along the kickboard in the kitchen”, “clean near the kitchen stove”, “clean under the living room couch”, or “clean the cabinets area of the kitchen sink”, etc. in an example, the object-based mission may be characterized by debris status in a room or an area, such as “clean the dirty areas.” The user experience-based mission routine may be characterized by, or made reference to, a user's time, pattern, frequency, or preference of using an room or an area in the environment, or a user's behavior or daily routine associated with use, non-use, or a manner of use of a room or an area in the environment. Examples of the experience-based mission routine may include an “after dinner clean routine” that defines cleaning tasks with regard to areas likely to be affected by preparation and serving of dinner (e.g., a kitchen floor and floor areas around the dining table), an “after shower clean routine” that defines cleaning tasks with regard to areas likely to be affected by a user taking a shower (e.g., bathroom floor), “clean all rooms after I leave the house”, or “clean the living room before I get home”.

At 740, the mobile robot may be navigated about the environment to conduct a mission in accordance with the received mission routine. The received mission routine may be interpreted, such as by the mission interpreter 543, to extract information about a location for the mission (e.g., rooms or area to be clean with respect to an object detected in the environment), time and/or order for executing the mission with respect to user experience, or a manner of cleaning the identified room or area. Semantic information of the object detected in the environment, user behaviors such as detected by the user behavior detector 530, and a map of the environment may be used to interpret the mission routine. For example, to interpret the mission “clean under the kitchen table”, semantic information of the “table”, such as its location (“kitchen”), can be extracted from the association between the object (“table”) and the room (“kitchen”). In another example, to interpret the mission “after dinner clean routine”, room or areas (e.g., a kitchen floor and floor areas around the dining table) associated with the user behavior or daily routine (“dinner”) may be identified. In yet another example, to interpret the missions “clean all rooms after I leave the house”, “clean the living room when it is unoccupied”, or “avoid cleaning when watch TV”, schedules (e.g., time or order) associated with the user behavior (“leaving the house”, being present in a room, or watching a TV) may be recognized from the mission routine.

In some examples, the experience-based mission routine may be automatically activated in response to a detection of user behavior, such as by the user behavior detector 530. In an example, the user behavior detector 530 may be communicatively coupled to one or more sensors including, for example, ambulatory sensors (e.g., the sensors included in the mobile robot, such as a camera), or stationary sensors positioned in rooms or appliances, such as in a smart home ecosystem. For example, the “after diner clean routine” may be activated in response to a detection of a dishwasher being turned on, such as via a sensor on the dishwasher. In another example, the “clean all rooms after I leave the house” may be activated in response to a detection of locking of an entry door or closing of a garage door, such as via a smart door lock sensor. In another example, user daily schedule may be retrieved from a user's digital calendar (such as one stored in the user's mobile phone), and a mission routine may be activated based on the schedules of calendar events.

At 750, mission routine and mission progress may be monitored, such as on a user interface of the handheld computing device. As illustrated in FIG. 6A, the user interface may display an at-a-glance view that progressively presents relevant information to the user. The information about the robots and mission routines may be organized and displayed in a number of “shelves” on the user interface, such as a robot information shelf, a mission routine shelf, and a mission status shelf, as illustrated in FIG. 6A. The at-a-glance view may display robot(s) involved in a mission, nature of the mission, tasks involved in a mission, or progress of a mission, as illustrated in FIGS. 6F and 6G. The at-a-glance view may include a map of the environment, and UI controls that enable a user to create or modify a map, as illustrated in FIG. 6H. Additionally, as illustrated in FIG. 6I, the at-a-glance view may include coaching or educational messages, recommendations, interactive trouble-shooting guides, reminders to perform maintenance, or a user survey.

In some examples, a user may use UI controls on the user interface to pause, abort, or modify a mission routine or a task therein such in response to a user input or a trigger event. The mission modification may be carried out during the execution of the mission routine. Examples of mission modification may include adding a new task to the mission, removing an existing from the mission, or prioritizing one or more tasks in the mission (e.g., change the order of the tasks, such as cleaning certain “hotspots” such as dirtier areas before other areas in a home). The trigger event that causes a change in time or order of the tasks in a mission can be a specific type of user behavior, such as room occupancy indicating a presence or absence of a person in a room, or user engagement in an audio-sensitive event, such as on a phone call, watching TV, listening to music, or having a conversation. In response of detection of such user behavior, the mission may be paused, or modified such as by rescheduling or postponing the task scheduled to be performed in the occupied room until it is no long occupied, or rescheduling or postponing the task that interferes with the audio-sensitive event until the audio-sensitive event is over.

### Examples of Machine-Readable Medium for Robot Scheduling and Controlling

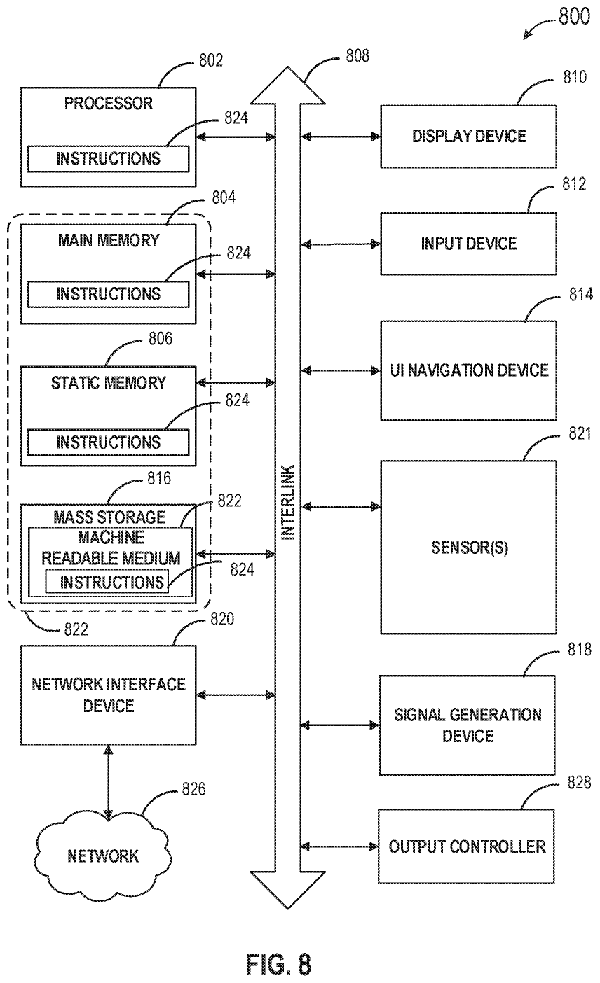

FIG. 8 illustrates generally a block diagram of an example machine 800 upon which any one or more of the techniques (e.g., methodologies) discussed herein may perform. Portions of this description may apply to the computing framework of various portions of the mobile robot 100, the mobile device 404, or other computing system such as a local computer system or the cloud computing system 406.

In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination., perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810 (e.g., a raster display, vector display, holographic display, etc.), an alphanumeric input device 812 (e.g., a keyboard), and a user interface (UI) navigation device 814 (e.g., a mouse). In an example, the display unit 810, input device 812 and 111 navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensors. The machine 800 may include an output controller 828, such as a serial (e.g., universal serial bus (USB), parallel, or other wired or wireless (e.g., infrared (IR), near field communication (NEC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine-readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EPSOM)) and flash memory devices; magnetic disks, such as internal hard disks and removable disks; magneto-optical disks; and CD-ROM and DVD-ROM disks.

The instructions 824 may further be transmitted or received over a communication network 826 using a transmission medium via the network interface device 820 utilizing any one of a number of transfer protocols (e.g., frame relay, internee protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as WiFi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communication network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

Various embodiments are illustrated in the figures above. One or more features from one or more of these embodiments may be combined to form other embodiments.

The method examples described herein can be machine or computer-implemented at least in part. Some examples may include a computer-readable medium or machine-readable medium encoded with instructions operable to configure an electronic device or system to perform methods as described in the above examples. An implementation of such methods may include code, such as microcode, assembly language code, a higher-level language code, or the like. Such code may include computer readable instructions for performing various methods. The code can form portions of computer program products. Further, the code can be tangibly stored on one or more volatile or non-volatile computer-readable media during execution or at other times.

The above detailed description is intended to be illustrative, and not restrictive. The scope of the disclosure should therefore be determined with references to the appended claims, along with the full scope of equivalents to which such claims are entitled.

What is claimed is:

1. A mobile cleaning robot, comprising:
a drive system configured to move the mobile cleaning robot about an environment;
a sensor circuit configured to detect an object in the environment; and
a controller circuit configured to:
receive a mission routine including data representing an editable schedule including at least one of time or order for performing one or more tasks with respect to a semantically annotated object, the semantically annotated object including spatial or contextual information of the detected object; and
navigate the mobile cleaning robot to conduct a mission in accordance with the mission routine.

2. The mobile cleaning robot of claim 1, wherein:
the sensor circuit is further configured to identify a spatial location of the detected object in the environment; and
the controller circuit is configured to associate the detected object with the identified spatial location to create the semantically annotated object, and to generate or modify the mission routine using the semantically annotated object.

3. The mobile cleaning robot of claim 2, wherein the detected object includes a furniture or a furnishing, and the controller circuit is configured to:
identify a room or an area in the environment where the furniture or furnishing is located;
associate the furniture or the furnishing with the identified room; and
generate or modify the mission routine based on the association between the furniture or furnishing and the identified room or area.

4. The mobile cleaning robot of claim 1, wherein the one or more tasks include cleaning one or more rooms or floor surface areas respectively characterized by their spatial or contextual relationship with the semantically annotated object.

5. The mobile cleaning robot of claim 1, wherein the one or more tasks include cleaning one or more rooms or floor surface areas respectively characterized by a user interaction therewith.

6. The mobile cleaning robot of claim 1, wherein the editable schedule for performing the one or more tasks is with respect to a user behavior, and
wherein the controller circuit is configured to receive information about the user behavior, and to navigate the mobile cleaning robot to conduct the mission based on the editable schedule and the received information about user behavior.

7. The mobile cleaning robot of claim 6, wherein the controller circuit is configured to modify at least one of time or order for performing the one or more tasks based on the received information about user behavior.

8. The mobile cleaning robot of claim 7, wherein the information about user behavior includes information about room occupancy indicating a presence or absence of a person in a target room, and
wherein the controller circuit is configured to pause the mission, or to reschedule a task to be performed in the target room based on the information about room occupancy.

9. The mobile cleaning robot of claim 7, wherein the information about user behavior includes information about user engagement in an audio-sensitive event, and
wherein the controller circuit is configured to pause the mission, or to reschedule a task interfering with the audio-sensitive event.

10. The mobile cleaning robot of claim 1, wherein the one or more tasks include cleaning one or more rooms or floor surface areas characterized by respective debris status therein, and wherein:
the sensor circuit is configured to detect respective levels of dirtiness or debris distributions in one or more rooms or floor surface areas; and
the controller circuit is configured to prioritize cleaning the one or more rooms or floor surface areas by the respective levels of dirtiness or debris distributions.

11. The mobile cleaning robot of claim 10, wherein the one or more tasks include a first area having a higher level of dirtiness than a second area, which has a higher level of dirtiness than a third area, and
wherein the controller circuit is configured to navigate the mobile cleaning robot to clean sequentially the first area first, following by the second area, followed by the third area.

12. The mobile cleaning robot of claim 1, wherein the mission routine further includes a cleaning mode representing a level of cleaning in a target area, and
wherein the controller circuit is configured to communicate with a light source to adjust illumination of the target area, and to navigate the mobile cleaning robot to clean the target area with the adjusted illumination.

13. The mobile cleaning robot of claim 1, wherein the controller circuit is configured to generate a mission status report of a progress of the mission or a task therein, the mission status report including at least one of elapsed time, remaining time estimate, or an overall time estimate for the mission or a task therein.

14. The mobile cleaning robot of claim 1, wherein the controller circuit is configured to prioritize a task in the mission routine based on a time allocation for completing a mission.

15. The mobile cleaning robot of claim 1, wherein the controller circuit is configured to generate or update a map of the environment including information about the semantically annotated object, and to navigate the mobile cleaning robot using the generated map.

16. A non-transitory machine-readable storage medium that includes instructions that, when executed by one or more processors of a machine, cause the machine to perform operations comprising:
establishing communication between the machine and at least one mobile cleaning robot configured to move about an environment;
controlling the at least one mobile cleaning robot to detect an object in the environment;
receiving a mission routine including data representing an editable schedule including at least one of time or order for performing one or more tasks with respect to a semantically annotated object, the semantically annotated object including spatial or contextual information of the detected object;
presenting on a display a graphical representation of the mission routine; and
navigating the at least one mobile cleaning robot to conduct a mission in accordance with the mission routine.

17. The non-transitory machine-readable storage medium of claim 16, wherein the instructions cause the machine to perform operations further comprising coordinating a suite of mobile robots in the environment including a first mobile cleaning robot and a different second mobile robot, the editable schedule including at least one of time or order for performing one or more tasks performed by the first mobile cleaning robot and one or more tasks performed by the second mobile robot.

18. The non-transitory machine-readable storage medium of claim 17, wherein the instructions cause the machine to perform operations further comprising, in response to a user input, switching between a presentation of an operating status of the first mobile cleaning robot and a presentation of an operating status of the second mobile cleaning robot on a user interface.

19. The non-transitory machine-readable storage medium of claim 17, wherein the operation of coordinating a suite of mobile robots includes adding a new mobile robot to the suite or removing an existing robot from the suite.

20. The non-transitory machine-readable storage medium of claim 16, wherein the one or more tasks include cleaning one or more rooms or floor surface areas respectively characterized by their spatial or contextual relationship with the semantically annotated object.

21. The non-transitory machine-readable storage medium of claim 16, wherein the one or more tasks include cleaning one or more rooms or floor surface areas respectively characterized by a user interaction therewith.

22. The non-transitory machine-readable storage medium of claim 16, wherein the editable schedule for performing the one or more tasks is with respect to a user behavior, and
wherein the instructions cause the machine to perform operations further comprising receiving information about user behavior, and navigating the at least one mobile cleaning robot to conduct the mission based on the editable schedule and the received information about user behavior.

23. The non-transitory machine-readable storage medium of claim 22, wherein the information about user behavior includes room occupancy indicating a presence or absence of a person in a room, and
wherein the instructions cause the machine to perform operations further comprising pausing the mission, or rescheduling a task to be performed in the room being occupied.

24. The non-transitory machine-readable storage medium of claim 22, wherein the information about user behavior includes an audio-sensitive event, and
wherein the instructions cause the machine to perform operations further comprising pausing the mission, or rescheduling a task that interferes with the audio-sensitive event.

25. The non-transitory machine-readable storage medium of claim 16, wherein the one or more tasks include cleaning one or more rooms or floor surface areas characterized by respective debris status therein, and wherein the instructions cause the machine to perform operations further comprising:
detecting respective levels of dirtiness or debris distributions in one or more rooms or floor surface areas; and
prioritizing cleaning the one or more rooms or floor surface areas by the respective levels of dirtiness or debris distributions.

26. A handheld computing device, comprising:
a user interface;
a communication circuit configured to communicate with a first mobile cleaning robot moving about an environment; and
a processor configured to:
receive, from the first mobile cleaning robot, information about an object detected in the environment;
receive a mission routine including data representing an editable schedule including at least one of time or order for performing one or more tasks with respect to a semantically annotated object, the semantically annotated object including spatial and contextual information of the detected object; and
generate instructions to navigate the first mobile cleaning robot to conduct a mission in accordance with the mission routine;
wherein the user interface is configured to display in separate categories graphical representations of the first mobile cleaning robot and the mission routine.

27. The handheld computing device of claim 26, wherein:
the processor is configured to generate a mission status report of a progress of the mission or a task therein, the mission status report including at least one of elapsed time, remaining time estimate, or an time estimate for the mission or a task therein; and
the user interface is configured to display in a separate category a graphical representation of the mission status report.

28. The handheld computing device of claim 26, wherein:
the processor is configured to coordinate a suite of mobile robots in the environment including the first mobile cleaning robot and a different second mobile robot; and
the user interface includes one or more user controls that enable a user to switch between a first graphical representation of an operating status of the first mobile cleaning robot, and a second graphical representation of an operating status of the second mobile robot.

29. The handheld computing device of claim 28, wherein the user interface includes one or more user controls that enable a user to coordinate the suite of mobile robots including add a new mobile robot to the suite or remove an existing robot from the suite.

30. The handheld computing device of claim 26, wherein the user interface is configured to display a graphical representation the mission routine including an indented list of the one or more tasks characterized by respective semantically annotated objects in respective rooms or surface areas in the environment.

31. The handheld computing device of claim 26, wherein the one or more tasks include cleaning one or more rooms or floor surface areas respectively characterized by their spatial or contextual relationship with the semantically annotated object.

32. The handheld computing device of claim 26, wherein the one or more tasks include cleaning one or more rooms or floor surface areas respectively characterized by a user interaction therewith.

33. The handheld computing device of claim 26, wherein the editable schedule for performing the one or more tasks is with respect to a user behavior; and
wherein the processor is configured to receive information about the user behavior, and to generate instructions to navigate the mobile cleaning robot to conduct the mission based on the editable schedule and the received information about user behavior.

34. The handheld computing device of claim 26, wherein the user interface is configured to receive from a user a voice command about the mission routine.
